(19) United States
(12) Patent Application Publication
(10) Pub. No.: US 2024/0217303 A1
(43) Pub. Date: Jul. 4, 2024

(54) HYDRAULIC SUSPENSION APPARATUS AND HYDRAULIC SUSPENSION SYSTEM AND VEHICLE HAVING SAME

(71) Applicant: BYD COMPANY LIMITED, SHENZHEN (CN)

(72) Inventors: Yubo LIAN, Shenzhen (CN); Yinsheng LIAO, Shenzhen (CN); Haolun XU, Shenzhen (CN); Hongzhou ZHANG, Shenzhen (CN); Taishuo HUANG, Shenzhen (CN)

(21) Appl. No.: 18/610,701

(22) Filed: Mar. 20, 2024

Related U.S. Application Data
(63) Continuation of application No. PCT/CN2022/143998, filed on Dec. 30, 2022.

(30) Foreign Application Priority Data
Dec. 30, 2021 (CN) 202111655945.3

(51) Int. Cl. B60G 17/08; B60G 13/08; B60G 13/14

(52) U.S. Cl. CPC B60G 17/08; B60G 13/08; B60G 13/14; B60G 2202/24; B60G 2206/41; B60G 2500/302; B60G 2800/01; B60G 2800/162; B60G 2800/914; B60G 2800/916

(57) ABSTRACT

A hydraulic suspension apparatus configured to adjust a height of a vehicle body of a vehicle, includes a liquid storage apparatus and a reducer. The liquid storage apparatus is disposed on the vehicle body and configured to store liquid. The reducer has a reducer housing, a piston, and a piston rod. The reducer housing is connected to an axle, and the piston is located in the reducer housing and divides the reducer housing into an upper chamber and a lower chamber. An end of the piston rod is connected to the piston, and the piston rod is connected to the vehicle body and includes a liquid channel. The liquid channel is communicated with the lower chamber and the liquid storage apparatus to enable liquid flowable between the liquid storage apparatus and the lower chamber.

### CROSS-REFERENCE TO RELATED APPLICATIONS

The application is a continuation application of International Patent Application No. PCT/CN2022/143998 filed on Dec. 30, 2022, which is based on and claims priority to and benefits of Chinese Patent Application No. 202111655945.3, filed on Dec. 30, 2021. The entire content of all of the above-referenced applications is incorporated herein by reference.

### FIELD

The present disclosure relates to the field of vehicles, and more particularly, to a hydraulic suspension apparatus and a hydraulic suspension system and a vehicle having same.

### BACKGROUND

A suspension is an apparatus that transfers forces between a vehicle body and an axle, is one of the four major parts of a car, and is a key part that affects the driving performance of the car. The suspension may transfer a force and a torque that are fed back by a road surface, attenuate the vibration of wheels, and cushion an impact, to improve the driving experience of a driver, thereby providing a vehicle with optimal motion characteristics and stable driving capability. A suspension in the related art is mostly formed by a spring, a guide mechanism, a reducer, and the like. Both a damping coefficient of the reducer and stiffness of the spring are fixed, and it is difficult to balance comfort and operation stability.

### SUMMARY

The present disclosure resolves one of technical problems existing in the related art at least to a certain extent.

For this, the present disclosure provides a hydraulic suspension apparatus, so that the operation stability of a vehicle can be improved without damaging the comfort of the vehicle.

The present disclosure further provides a hydraulic suspension system having the foregoing hydraulic suspension apparatus.

The present disclosure further provides a vehicle having the foregoing hydraulic suspension system.

A hydraulic suspension apparatus according to embodiments of the present disclosure is configured to adjust a height of a vehicle body of a vehicle. The hydraulic suspension apparatus includes a liquid storage apparatus and a reducer. The liquid storage apparatus is disposed on the vehicle body and configured to store liquid/oil. The reducer has a reducer housing, a piston, and a piston rod. The reducer housing is connected to an axle, and the piston is located in the reducer housing and divides the reducer housing into an upper chamber and a lower chamber. An end of the piston rod is connected to the piston, and the piston rod is connected to the vehicle body and includes a liquid channel. The liquid channel is communicated with the lower chamber and the liquid storage apparatus to enable liquid flowable between the liquid storage apparatus and the lower chamber.

According to the hydraulic suspension apparatus in the embodiments of the present disclosure, an oil/liquid path can be stably communicated, wear or the like at a joint due to vibration is avoided, and liquid leakage at a joint can be avoided as much as possible. In addition, the weight can be reduced by using the hollow piston rod, and the oil/liquid channel defined by the hollow piston rod is further used to implement intake or discharge of oil/liquid to adjust the position of the piston rod. The adjustment manner is simple, the reliability is high, the costs are low, and the response speed is fast. Further, a height of a vehicle body may be adjusted, and the operation stability of a vehicle can be improved without damaging the comfort of the vehicle, so that the contradiction between the comfort and the steering stability of the vehicle is effectively resolved.

In some embodiments of the present disclosure, the liquid storage apparatus includes a control pump and a liquid storage device, and the control pump is disposed between the liquid storage device and the liquid channel.

In some embodiments of the present disclosure, an upper end of the piston rod extends out of the reducer housing, a liquid port is formed at the upper end of the piston rod, and the liquid port is configured to communicate the liquid channel with the liquid storage apparatus.

In some embodiments of the present disclosure, the hydraulic suspension apparatus further includes a liquid outlet channel and a liquid return channel, wherein the liquid outlet channel and the liquid return channel are communicated between the liquid storage device and the liquid channel, the liquid outlet channel and the liquid return channel partially overlap, and the control pump is disposed on the liquid outlet channel.

In some embodiments of the present disclosure, the liquid outlet channel includes a shared channel and a liquid outlet branch; the liquid return channel comprises the shared channel and a liquid return branch; a first end of the shared channel is communicated with the liquid channel; and the liquid outlet branch and the liquid return branch are communicated with a second end of the shared channel.

In some embodiments of the present disclosure, a one-way valve and the control pump are disposed on the liquid outlet branch, a first end of the one-way valve is communicated with the shared channel, a second end of the one-way valve is communicated with the control pump, and a liquid return valve is disposed on the liquid return branch.

In some embodiments of the present disclosure, the hydraulic suspension apparatus further includes an accumulator module, the liquid channel is communicated with the liquid storage apparatus through a communicating channel, the accumulator module is communicated with the communicating channel and is configured to adjust at least one of damping of the reducer, stiffness of the reducer and the height of the vehicle body of the vehicle.

In some embodiments of the present disclosure, the hydraulic suspension system further includes a first control valve, and the first control valve is disposed on the communicating channel, and is configured to control communication or separation between the liquid storage apparatus and the accumulator module.

In some embodiments of the present disclosure, the accumulator module includes a first accumulator and an openness-adjustment valve, the first accumulator is communicated with the communicating channel at a first communicating point, the openness-adjustment valve is disposed between the first communicating point and the liquid channel, the openness-adjustment valve is configured to adjust a flow between the liquid channel and the first communicating point to adjust the damping of the reducer, and the openness-adjustment valve is configured to turn off the flow between the liquid channel and the first communicating point, to adjust the stiffness of the reducer.

In some embodiments of the present disclosure, the accumulator module further includes a second accumulator and a stiffness-adjustment valve, the second accumulator is communicated with the communicating channel at a second communicating point, the stiffness-adjustment valve is disposed between the second accumulator and the second communicating point, and configured to enable communication or separation between the communicating channel and the second accumulator to adjust the stiffness of the reducer.

In some embodiments of the present disclosure, a second control valve is further disposed between the second communicating point and the liquid channel.

In some embodiments of the present disclosure, the accumulator module further includes a first accumulator and a second accumulator, the first accumulator is communicated with the communicating channel at a first communicating point, and the second accumulator is communicated with the communicating channel at a second communicating point.

In an embodiment, the first communicating point is located between the liquid channel and the second communicating point.

In an embodiment, a second control valve is disposed between the first communicating point and the second communicating point.

A hydraulic suspension system according to embodiments of the present disclosure includes a controller and the hydraulic suspension apparatus in any foregoing embodiment of the present disclosure. The controller is configured to control a flow direction of liquid between the liquid storage apparatus and the reducer according to a status of a vehicle, to increase or reduce a height of a vehicle body of the vehicle.

A vehicle according to embodiments of the present disclosure includes the hydraulic suspension system according to the foregoing embodiments of the present disclosure.

The additional aspects and advantages of the present disclosure will be set forth in part in the description below, parts of which will become apparent from the description below, or will be understood by the practice of the present disclosure.

### BRIEF DESCRIPTION OF THE DRAWINGS

FIG. 1 is a schematic diagram of a hydraulic suspension system according to some embodiments of the present disclosure;

FIG. 2 is a schematic diagram of a hydraulic suspension system according to some other embodiments of the present disclosure;

FIG. 3 is a schematic diagram of a hydraulic suspension system according to some embodiments of the present disclosure, where the hydraulic suspension system has an anti-tip function;

FIG. 4 is a schematic diagram of the hydraulic suspension system shown in FIG. 3 in a pressurization mode;

FIG. 5 is a schematic diagram of the hydraulic suspension system shown in FIG. 3 in a lift mode;

FIG. 6 is a schematic diagram of the hydraulic suspension system shown in FIG. 3 in a height-reduction mode;

FIG. 7 is a schematic diagram of the hydraulic suspension system shown in FIG. 3 in a braking anti-dive and acceleration anti-lift mode;

FIG. 8 is a schematic diagram of the hydraulic suspension system shown in FIG. 3 in an anti-tip working condition;

FIG. 9 is a schematic diagram of a hydraulic suspension system according to some embodiments of the present disclosure, where the hydraulic suspension system has an anti-pitch mode;

FIG. 10 is a schematic diagram of a hydraulic suspension system according to some other embodiments of the present disclosure, where the hydraulic suspension system has an anti-pitch mode;

FIG. 11 is a schematic diagram of a hydraulic suspension system according to still some other embodiments of the present disclosure;

FIG. 12 is a schematic diagram of a hydraulic suspension system according to yet some other embodiments of the present disclosure;

FIG. 13 is a schematic diagram of the hydraulic suspension system shown in FIG. 12 in a pressurization mode;

FIG. 14 is a schematic diagram of the hydraulic suspension system shown in FIG. 12 in a lift mode;

FIG. 15 is a schematic diagram of the hydraulic suspension system shown in FIG. 12 in a height-keeping mode;

FIG. 16 is a schematic diagram of the hydraulic suspension system shown in FIG. 12 in a height-reduction mode;

FIG. 17 is a schematic diagram of the hydraulic suspension system shown in FIG. 12 in an anti-tip mode;

FIG. 18 is a schematic diagram of the hydraulic suspension system shown in FIG. 12 in an anti-pitch mode;

FIG. 19 is a schematic diagram of the hydraulic suspension system shown in FIG. 12 in an anti-tip mode and a height-keeping mode;

FIG. 20 and FIG. 21 are schematic diagrams of a hydraulic suspension system according to different embodiments of the present disclosure;

FIG. 22 is a schematic diagram of a left-front side reducer assembly and a right-front side reducer assembly according to an embodiment of the present disclosure;

FIG. 23 is a cross-sectional view of the reducer assembly shown in FIG. 22;

FIG. 24 is a cross-sectional view of a central control cylinder according to an embodiment of the present disclosure;

FIG. 25 is a three-dimensional view of a central control cylinder according to an embodiment of the present disclosure; and

FIG. 26 is a schematic diagram of a metal bellows accumulator according to an embodiment of the present disclosure.

### REFERENCE NUMERALS

hydraulic suspension system 1000, liquid storage device 1, reducer assembly 2, reducer 200, reducer housing 201, upper chamber 2011, lower chamber 2012, piston 202, piston rod 203, liquid channel 204, vibration reduction spring 205, and first control valve 3, first height control valve 6, second height control valve 7, openness-adjustment valve 8, first accumulator 9, second accumulator 10, metal bellows 101, stiffness-adjustment valve 11, second control valve 12, central accumulator 13, central energy storage adjustment valve 32, first adjustment accumulator 14, second adjustment accumulator 15, third adjustment accumulator 16, fourth adjustment accumulator 17, first adjustment valve 18, second adjustment valve 19, third adjustment valve 20, fourth adjustment valve 21, first on-off valve 22, second on-off valve 23, central control cylinder 24, second cylinder body 240, movement member 241, movement body portion 2410, middle contact portion 2411, first chamber 243, second chamber 244, third chamber 245, fourth chamber 246, first reset spring 247, second reset spring 248, guide assembly 249, first guide member 2490, second guide member 2491, control pump 26, control valve body 260, drive motor 261, liquid return valve 27, one-way valve 28, constant pressure accumulator 29, reduced pressure accumulator 30, relief valve 31, shared channel 33, liquid outlet branch 34, and liquid return branch 35.

### DETAILED DESCRIPTION

The following describes embodiments of the present disclosure in detail. Examples of the embodiments are shown in the accompanying drawings, and same or similar reference signs in all the accompanying drawings indicate same or similar components or components having same or similar functions. The embodiments that are described with reference to the accompanying drawings are examples, and are used to interpret the present disclosure, instead limiting the present disclosure.

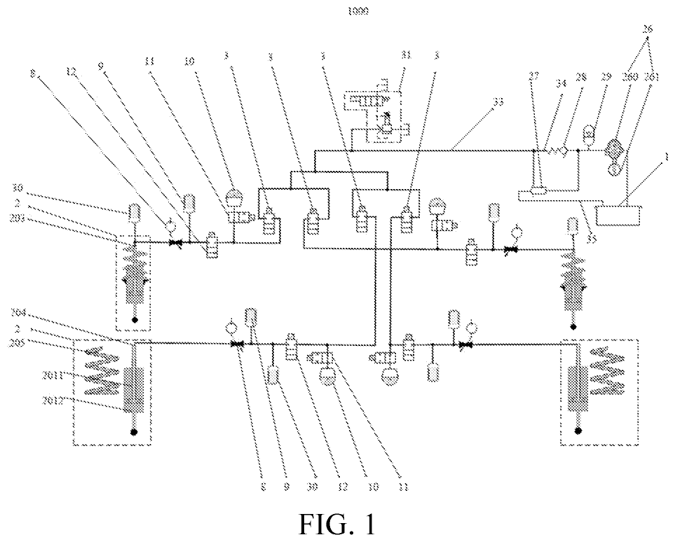

A hydraulic suspension apparatus according to embodiments of the present disclosure is described below with reference to FIG. 1 to FIG. 26. The hydraulic suspension apparatus is used on a vehicle. The hydraulic suspension apparatus is configured to connect an axle and a vehicle body of the vehicle, and is configured to adjust a height of the vehicle body of the vehicle.

As shown in FIG. 1 to FIG. 23, the hydraulic suspension apparatus according to the embodiments of the present disclosure includes a liquid storage apparatus and a reducer 200. The liquid storage apparatus is arranged/disposed on the vehicle body and is configured to store liquid, such as oil or other suitable liquid materials. The reducer 200 has a reducer housing 201, a piston 202, and a piston rod 203. The reducer housing 201 is connected to the axle. The piston 202 is located in the reducer housing 201 and fits the reducer housing 201 to divide the reducer housing 201 into an upper chamber 2011 and a lower chamber 2012. An end of the piston rod 203 is connected to the piston 202. The piston rod 203 is connected to the vehicle body. A liquid channel 204 is provided in the piston rod 203. The liquid channel 204 is communicated with the lower chamber 2012 and the liquid storage apparatus, to make liquid flowable between the liquid storage apparatus and the lower chamber 2012.

It may be understood that, in a driving process of the vehicle, the axle vibrates, for example, shakes, relative to the vehicle body. When the hydraulic suspension apparatus according to the embodiments of the present disclosure is mounted on the vehicle, the reducer housing 201 is mounted on the axle, and the piston rod 203 is connected to the vehicle body. As can be learned, a top end of the piston rod 203 is stationary relative to the vehicle body, and the reducer housing 201 may move relative to the piston rod 203 along with the axle. Because the liquid channel 204 of the piston rod 203 is communicated with the liquid storage apparatus through a liquid path, the impact of the vibration of the axle on the communication of the liquid path can be reduced, so that the liquid path can be stably communicated, wear at a joint between the liquid path and the liquid storage apparatus can be reduced, and wear at a joint between the liquid path and the piston rod 203 is reduced.

It may further be understood that, liquid in the liquid storage apparatus may enter the lower chamber 2012 through the liquid channel 204. When the piston rod 203 moves downward to make a volume in the lower chamber 2012 decrease, liquid in the lower chamber 2012 may be discharged to the liquid storage apparatus through the liquid channel 204.

In an embodiment, the hydraulic suspension apparatus has a lift mode and a height reduction mode. In the lift mode, liquid of the liquid storage apparatus may enter the liquid channel 204. Hydraulic liquid that enters the liquid channel 204 flows into the lower chamber 2012, to enable hydraulic pressure in the lower chamber 2012 to increase to enable the piston 202 to move upward. The piston 202 moves upward to drive the piston rod 203 to move upward, to lift the vehicle body.

In the height reduction mode, the liquid in the liquid storage apparatus no longer enters the liquid channel. liquid in the reducer 200 may flow out of the liquid channel 204 under the action of the gravity of the vehicle. The hydraulic pressure in the lower chamber 2012 of the reducer 200 decreases to enable the piston 202 to move downward. The piston 202 moves downward to drive the piston rod 203 to move downward, to drive the vehicle body to move downward, to reduce the height of the vehicle body.

In the driving process, the vehicle may encounter various road conditions. Once a suspension system of the vehicle in the related art is chosen, the suspension system may not be adjusted in a driving process of a car. As a result, a conventional suspension can only ensure that the car reaches matching of optimal performance on a road and under a speed condition, and can only passively bear a force on the vehicle body by the ground. Parameters of the suspension may not be changed according to different roads and vehicle speeds, and the force on the vehicle body by the ground may not be actively controlled.

The hydraulic suspension apparatus according to the embodiments of the present disclosure may adjust the height of the vehicle body according to a road condition or the like. For example, on a relatively bumpy mountain road, the hydraulic suspension apparatus may enter the lift mode to raise the center of gravity of the vehicle, thereby improving the driving stability of the vehicle. When an impact of the vehicle body on a driving speed needs to be reduced, the hydraulic suspension apparatus may enter the height reduction mode to lower the center of gravity of the vehicle. It may be understood that, the foregoing is only an example of description, and the height of the vehicle body may be adjusted according to an actual requirement in a driving process.

For the hydraulic suspension apparatus according to the embodiments of the present disclosure, the liquid channel 204 communicated with the lower chamber 2012 is opened at the piston rod 203, and the liquid channel 204 is communicated with the liquid storage apparatus. Therefore, an liquid path can be stably communicated, wear or the like at a joint due to vibration is avoided, and liquid leakage at a joint can be avoided as much as possible. In addition, the weight can be reduced by using the hollow piston rod 203, and the liquid channel 204 defined by the hollow piston rod 203 is further used to implement intake or discharge of liquid to adjust the position of the piston rod 203. The adjustment manner is simple, the reliability is high, the costs are low, and the response speed is fast. Further, a height of a vehicle body may be adjusted, and the operation stability of a vehicle can be improved without damaging the comfort of the vehicle, so that the contradiction between the comfort and the steering stability of the vehicle is effectively resolved.

As shown in FIG. 1 to FIG. 23, in some embodiments of the present disclosure, an upper end of the piston rod 203 extends out of the reducer housing 201. A liquid port is formed at the upper end of the piston rod 203. The liquid port is configured to communicate the liquid channel 204 and the liquid storage apparatus. In this way, the liquid port provided at the upper end of the piston rod 203 facilitates the communication between the liquid path and the liquid port, thereby improving mounting efficiency.

In some embodiments of the present disclosure, as shown in FIG. 1 to FIG. 21, the liquid storage apparatus includes a control pump 26 and a liquid storage device 1. The control pump 26 is arranged between the liquid storage device 1 and the liquid channel 204. In an embodiment, liquid is stored in the liquid storage device 1. The control pump 26 may pump the liquid in the liquid storage device 1 to the liquid channel 204. In this way, through the arrangement of the control pump 26, a mounting position of the liquid storage device 1 is not restricted, and the position of the liquid storage device 1 may be appropriately arranged according to a space of the vehicle.

In an embodiment, the hydraulic suspension apparatus further includes a liquid outlet channel and a liquid return channel. The liquid outlet channel and the liquid return channel are both communicated between the liquid storage device 1 and the liquid channel 204. The liquid outlet channel and the liquid return channel partially overlap. The control pump 26 is arranged on the liquid outlet channel. That is, the return channel in the liquid storage device 1 is discharged to the liquid channel 204 through the liquid outlet channel. The return channel in the liquid channel 204 is discharged to the liquid storage device 1 through the liquid return channel. In this way, through the arrangement of the liquid outlet channel and the liquid return channel, independent return channel discharge and return channel return can be implemented, to ensure reliable liquid discharge and liquid return. Further, because the liquid outlet channel and the liquid return channel partially overlap, a quantity of connecting pipes can be reduced, to make the hydraulic suspension apparatus more compact.

In some examples of the present disclosure, as shown in FIG. 1 to FIG. 21, the liquid outlet channel includes a shared channel 33 and a liquid outlet branch 34. The liquid return channel includes the shared channel 33 and an liquid return branch 35. One end (e.g., a first end) of the shared channel 33 is communicated with the liquid channel 204. The liquid outlet branch 34 and the liquid return branch 35 are both communicated with the other end (e.g., a second end) of the shared channel 33. That is, an overlapping part between the liquid outlet channel and the liquid return channel is the shared channel 33. The liquid outlet branch 34 is communicated with a liquid discharge port of the liquid storage device 1. The liquid return branch 35 is communicated with a liquid inlet port of the liquid storage device 1. The control pump 26 is arranged on the liquid outlet branch 34. In this way, the liquid in the liquid storage device 1 may be discharged to the liquid channel 204 through the liquid outlet branch 34 and the shared channel 33. The liquid in the liquid channel 204 may be discharged back into the liquid storage device 1 through the shared channel 33 and the liquid return branch 35. In this way, the reliability of liquid return and liquid discharge is ensured.

In an embodiment, as shown in FIG. 1 to FIG. 21, a one-way valve 28 and the control pump 26 are arranged on the liquid outlet branch 34. One end (e.g., a first end) of the one-way valve 28 is communicated with the shared channel 33. The other end (e.g., a second end) of the one-way valve 28 is communicated with the control pump 26. A liquid return valve 27 is arranged on the liquid return branch 35. In an embodiment, the liquid storage device 1 has a liquid return channel and a liquid discharge channel that are independent. When liquid discharge is required, the control pump 26 is opened and the liquid return valve 27 is in a closed state, and the control pump 26 guides liquid to the liquid channel 204 of the reducer 200. When liquid return is required, the control pump 26 is closed and the liquid return valve 27 is opened, and liquid that flows out of the liquid channel 204 of the reducer 200 may flow to the liquid storage device 1 through the liquid return valve 27. During liquid return, due to the presence of the one-way valve 28, liquid can be effectively kept from flowing to the control pump 26, to prevent liquid from flowing to the liquid discharge port through the control pump 26 when the control pump 26 encounters an accident. In this way, reliable liquid discharge and liquid return are ensured.

In some examples of the present disclosure, as shown in FIG. 1 to FIG. 21, the control pump 26 includes a control valve body 260 and a drive motor 261. The drive motor 261 is electrically connected to a valve in the control valve body 260. The drive motor 261 rotates to control the valve to rotate to open or close the control pump 26. In this way, in a manner that the drive motor 261 fits the valve, the control pump 26 is opened or closed, so that relatively reliable running of the control pump 26 can be ensured, to reduce an impact of liquid on opening or closing of the control pump 26.

According to some embodiments of the present disclosure, as shown in FIG. 1 to FIG. 12, the hydraulic suspension apparatus further includes a relief valve 31. The relief valve 31 is located at a discharge end port of the control pump 26. When pressure in the liquid discharge port of the control pump 26 reaches a threshold, the relief valve 31 is opened to release pressure. In this way, the hydraulic suspension apparatus is protected to be kept in a normal pressure range. It needs to be noted that, the working principle of the relief valve 31 is the related art, and details are not described herein.

In some embodiments of the present disclosure, as shown in FIG. 1 to FIG. 21, the hydraulic suspension apparatus further includes a constant pressure accumulator 29. The constant pressure accumulator 29 is arranged at an outlet end of the control pump 26. In this way, the constant pressure accumulator 29 may stabilize the pressure and eliminate discharge fluctuations at the outlet end of the control pump 26.

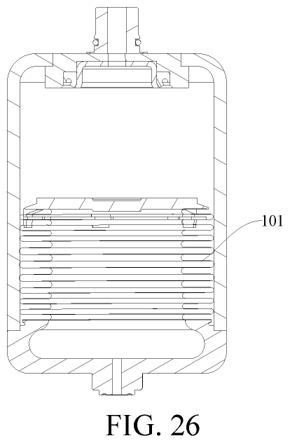

In some examples of the present disclosure, the constant pressure accumulator 29 may be a metal bellows accumulator. As shown in FIG. 26, the metal bellows accumulator is formed by a cylinder body assembly and a bellows assembly. The cylinder body assembly includes an upper cover, a seal ring, a cylinder, a clamp ring, and a seal loop. The bellows assembly includes a seal cover, a guide loop, bellows, and a lower cover. The metal bellows accumulator may replace a gas bag or a membrane. Metal bellows 101 are used as a flexible separation element between fluid and gas. The bellows may be used in a very wide temperature range. The metal bellows are welded to another part, and therefore are completely airtight. The metal bellows can move vertically inside the accumulator without generating any friction or wear, and only needs to be adjusted once before the metal bellows can run for a very long time.

In some embodiments of the present disclosure, the hydraulic suspension apparatus further includes an accumulator module. The liquid channel 204 is communicated with the liquid storage apparatus through a communicating channel. The accumulator module is communicated with the communicating channel, and the accumulator module at least adjusts at least one of damping and stiffness of the reducer 200 and the height of the vehicle body of the vehicle. It needs to be explained that the accumulator module implements energy storage. That is, liquid may flow into the accumulator module for energy storage. When the hydraulic suspension apparatus needs liquid, liquid in the accumulator module is discharged for supplement.

In an embodiment, when the accumulator module may be configured to adjust the height of the vehicle body of the vehicle, in this case, the liquid in the accumulator module may be discharged to the liquid channel 204 to enter the lower chamber 2012, or the liquid in the lower chamber 2012 may be discharged to the accumulator module for energy storage. When the accumulator module is configured to adjust the damping of the reducer 200, in this case, a flow channel of the communicating channel becomes narrower or wider to adjust the damping (that is, flow resistance of the liquid entering or leaving the reducer 200 increases or decreases). When the accumulator module is configured to adjust stiffness of the reducer 200, it is selected to communicate the communicating channel and the accumulator module, or it is selected to block the communication between the accumulator module and the communicating channel. In this way, an adjustment function of the hydraulic suspension apparatus may be added, to make driving of a vehicle arranged with the hydraulic suspension apparatus steadier.

As shown in FIG. 1 to FIG. 21, in some embodiments of the present disclosure, the hydraulic suspension system further includes a first control valve 3. The first control valve 3 is arranged on the communicating channel, and is configured to control communication or separation between the liquid storage apparatus and the accumulator module. That is, when the first control valve 3 cuts off the communicating channel, a flow channel between the liquid storage apparatus and the accumulator module is blocked, and the liquid in the liquid storage apparatus does not flow into the accumulator module. In this way, through the arrangement of the first control valve 3, it may be determined whether the accumulator module requires energy storage. When energy storage is required, the first control valve 3 is opened. When energy storage is completed, the first control valve 3 is closed, and the accumulator module is used to adjust at least one of the damping and stiffness of the reducer 200 and the height of the vehicle body of the vehicle.

As shown in FIG. 1 to FIG. 21, in some embodiments of the present disclosure, the accumulator module includes a first accumulator 9 and an openness-adjustment valve 8. The first accumulator 9 is communicated with the communicating channel at a first communicating point. The openness-adjustment valve 8 is arranged between the first communicating point and the liquid channel 204. The openness-adjustment valve 8 is configured to adjust flow of a communicating channel or the flow between the liquid channel 204 and the first communicating point, to adjust the damping of the reducer 200. The openness-adjustment valve 8 is further configured to close a communicating channel or turn off the flow between the liquid channel 204 and the first communicating point, to adjust the stiffness of the reducer 200.

In an embodiment, the first accumulator 9 may perform energy storage. When the openness-adjustment valve 8 is in an open state and openness of the openness-adjustment valve 8 decreases to make an amount of liquid that is allowed to circulate in the communicating channel decrease, the flow channel from the reducer 200 to the communicating channel becomes narrower, and the damping increases. When the openness of the openness-adjustment valve 8 increases, the flow channel from the reducer 200 to the communicating channel becomes wider, and the damping decreases. Therefore, the first accumulator 9 and the openness-adjustment valve 8 fit together, to ensure the reliability of adjusting the damping of the hydraulic suspension apparatus, thereby ensuring that the amount of liquid that circulates in the communicating channel matches required damping. In other words, an liquid discharge in a corresponding communicating channel may be adjusted through the openness-adjustment valve 8. Therefore, damping of the corresponding communicating channel may be adjusted, to adjust the damping of the hydraulic suspension apparatus. In this way, damping of a hydraulic suspension system 1000 may be adjusted according to an actual case, for example, may be adjusted according to a road condition or the like, to ensure that the damping of the hydraulic suspension system 1000 can meet a vibration reduction requirement, thereby effectively resolving the contradiction between the comfort and the steering stability of the vehicle.

When the openness-adjustment valve 8 is in a closed state, the reducer 200 and the first accumulator 9 are disconnected. The liquid in the reducer 200 may not be discharged to the first accumulator 9. The liquid in the first accumulator 9 also may not be discharged into the reducer 200. Therefore, the stiffness of the reducer 200 can be improved. In this case, the openness-adjustment valve 8 is a cut-off adjustment valve, so that the flow can be adjusted, and cut-off and communication can be implemented.

In some examples of the present disclosure, the openness-adjustment valve 8 includes a first motor and a first valve body. The first motor may control the motion of a valve in the first valve body, to change a circulation area of the first valve body to adjust a discharge.

According to some embodiments of the present disclosure, the accumulator module further includes a second accumulator 10 and a stiffness-adjustment valve 11. The second accumulator 10 is communicated with the communicating channel at a second communicating point. The stiffness-adjustment valve 11 is arranged between the second accumulator 10 and the second communicating point. The stiffness-adjustment valve 11 is configured to enable the communication or separation between the communicating channel and the second accumulator 10 to adjust the stiffness of the reducer 200. In an embodiment, when the stiffness-adjustment valve 11 is opened, liquid can circulate between the second accumulator 10 and the reducer 200. When the stiffness-adjustment valve 11 is closed, the second accumulator 10 and the reducer 200 are disconnected. In this way, the liquid in the reducer 200 may not be discharged into the second accumulator 10. liquid in the second accumulator 10 also may not be discharged into the reducer 200. In this way, the stiffness of the reducer 200 can be increased.

In an embodiment, as shown in FIG. 1 to FIG. 9, a second control valve 12 is further arranged between the second communicating point and the liquid channel 204. In this way, when the second control valve 12 is closed and the stiffness-adjustment valve 11 is opened, the liquid in the liquid storage device 1 may enter the second accumulator 10 for energy storage. In this way, through the arrangement of the second control valve 12, so that the energy storage of the second accumulator 10 can be performed.

As shown in FIG. 1 to FIG. 21, the accumulator module further includes a first accumulator 9 and a second accumulator 10. The first accumulator 9 is communicated with the communicating channel at a first communicating point. The second accumulator 10 is communicated with the communicating channel at a second communicating point. In an embodiment, through the arrangement of the first accumulator 9 and the second accumulator 10, the first accumulator 9 and the second accumulator 10 may be used to adjust stiffness of the communicating channel. In an embodiment, the first communicating point is located between the liquid channel 204 and the second communicating point.

In some examples of the present disclosure, a second control valve 12 is arranged between the first communicating point and the second communicating point. In this way, through opening or closing of the second control valve 12, a quantity of accumulators communicated with the reducer 200 may be controlled, to adjust the stiffness or damping of the reducer 200.

A hydraulic suspension system 1000 according to embodiments of the present disclosure is described below with reference to FIG. 1 to FIG. 26. The hydraulic suspension system 1000 is used on a vehicle. The hydraulic suspension system 1000 is configured to connect an axle and a vehicle body of the vehicle.

A hydraulic suspension system according to embodiments of the present disclosure includes a controller and the hydraulic suspension apparatus in any foregoing embodiment of the present disclosure. The controller is configured to control a flow direction of liquid or liquid between the liquid storage apparatus and the reducer according to a status of a vehicle, to increase or reduce a height of a vehicle body of the vehicle.

It needs to be noted that, the hydraulic suspension system 1000 according to the embodiments of the present disclosure includes a number of reducer assemblies 2.

The number of reducer assemblies 2 include a left-front reducer assembly 2, a left-rear reducer assembly 2, a right-front reducer assembly 2, and a right-rear reducer assembly 2. Each reducer assembly 2 includes a reducer 200. It needs to be noted that, in the description of the present disclosure, “front” refers to a direction facing the vehicle head, and “rear” refers to a direction facing the vehicle tail. In a direction facing the front, the right hand direction of a driver is the right side, and the left hand direction of the driver is the left side.

The liquid channel 204 of each reducer assembly 2 is communicated with the liquid storage apparatus through the communicating channel. The liquid in the liquid storage apparatus enters each liquid channel 204 to enable the piston 202 to move upward, and the piston 202 drives the piston rod 203 and the vehicle body to move upward. In the height reduction mode, the liquid in each lower chamber 2012 is discharged to the liquid storage apparatus through the liquid channel 204, to enable the piston 202 to move downward, and the piston 202 drives the piston rod 203 and the vehicle body to move downward.

In an embodiment, the hydraulic suspension system 1000 has the lift mode and the height reduction mode. The controller controls the hydraulic suspension system 1000 according to the status of the vehicle to switch between the lift mode and the height reduction mode. In the lift mode, liquid may enter the liquid channel 204 of the left-front reducer assembly 2, the liquid channel 204 of the right-front reducer assembly 2, the liquid channel 204 of the left-rear reducer assembly 2, and the liquid channel 204 of the right-rear reducer assembly 2. Hydraulic liquid that enters each liquid channel 204 flows into the lower chamber 2012, to enable the hydraulic pressure in the lower chamber 2012 to increase to enable the piston 202 to move upward, and the piston 202 moves upward to drive the piston rod 203 to move upward. The piston rod 203 of the left-front reducer assembly 2 moves upward, the piston rod 203 of the right-front reducer assembly 2 moves upward, the piston rod 203 of the left-rear reducer assembly 2 moves upward, and the piston rod 203 of the right-rear reducer assembly 2 moves upward to drive the vehicle body to move upward, to lift the vehicle body.

In the height reduction mode, under the action of gravity, liquid may flow out from the liquid channel 204 of the left-front reducer assembly 2, the liquid channel 204 of the right-front reducer assembly 2, the liquid channel 204 of the left-rear reducer assembly 2, and the liquid channel 204 of the right-rear reducer assembly 2. The hydraulic pressure in the lower chamber 2012 of each reducer 200 decreases to enable the piston 202 to move downward, and the piston 202 moves downward to drive the piston rod 203 to move downward. The piston rod 203 of the left-front reducer assembly 2 moves downward, the piston rod 203 of the right-front reducer assembly 2 moves downward, the piston rod 203 of the left-rear reducer assembly 2 moves downward, and the piston rod 203 of the right-rear reducer assembly 2 moves downward to drive the vehicle body to move downward, to reduce the height of the vehicle body.

In the driving process, the vehicle may encounter various road conditions. Once a suspension system of the vehicle in the related art is chosen, the suspension system may not be adjusted in a driving process of a car. As a result, a conventional suspension can only ensure that the car reaches matching of optimal performance on a road and under a speed condition, and can only passively bear a force on the vehicle body by the ground. Parameters of the suspension may not be changed according to different roads and vehicle speeds, and the force on the vehicle body by the ground may not be actively controlled.

The hydraulic suspension system 1000 according to the embodiments of the present disclosure may adjust the height of the vehicle body according to a road condition or the like. For example, on a relatively bumpy mountain road, the hydraulic suspension apparatus may enter the lift mode to raise the center of gravity of the vehicle, thereby improving the driving stability of the vehicle. When an impact of the vehicle body on a driving speed needs to be reduced, the hydraulic suspension apparatus may enter the height reduction mode to lower the center of gravity of the vehicle. It may be understood that, the foregoing is only an example of description, and the height of the vehicle body may be adjusted according to an actual requirement in a driving process.

The hydraulic suspension system 1000 according to the embodiments of the present disclosure may adjust a height of a vehicle body, and can improve the operation stability of a vehicle without damaging the comfort of the vehicle, so that the contradiction between the comfort and the steering stability of the vehicle is effectively resolved. In addition, the weight can be reduced by using the hollow piston rod 203, and the liquid channel 204 defined by the hollow piston rod 203 is further used to implement intake or discharge of liquid to adjust the position of the piston rod 203. The adjustment manner is simple, the reliability is high, the costs are low, and the response speed is fast. Further, the liquid channel 204 communicated with the lower chamber 2012 is opened at the piston rod 203, and the liquid channel 204 is communicated with the liquid storage apparatus. Therefore, an liquid path can be stably communicated, wear or the like at a joint due to vibration is avoided, and liquid leakage at a joint can be avoided as much as possible.

In some examples of the present disclosure, the first control valve 3 configured to communicate or cut off each communicating channel is arranged on the communicating channel. That is, when the first control valve 3 corresponding to each reducer assembly 2 cuts off the corresponding communicating channel, the flow channel between the liquid storage device 1 and the liquid channel 204 corresponding to the reducer assembly 2 is blocked, the liquid in the liquid storage device 1 is kept from flowing into the corresponding reducer 200, and the liquid in the reducer 200 is also kept from flowing to the liquid storage device 1.

As shown in FIG. 10 and FIG. 12 to FIG. 21, in some embodiments of the present disclosure, the hydraulic suspension system 1000 further includes a first height keeping branch and a second height keeping branch. The first height keeping branch is communicated with the liquid channel 204 of the left-front reducer assembly 2 and the liquid channel 204 of the right-front reducer assembly 2, and a first height control valve 6 configured to communicate or cut off the first height keeping branch is arranged on the first height keeping branch.

The second height keeping branch is communicated with the liquid channel 204 of the left-rear reducer assembly 2 and the liquid channel 204 of the right-rear reducer assembly 2, and a second height control valve 7 configured to communicate or cut off the second height keeping branch is arranged on the second height keeping branch.

In an embodiment, when the first height control valve 6 is opened, the first height keeping branch is communicated. When the first height control valve 6 is closed, the first height keeping branch is cut off. When the second height control valve 7 is opened, the second height keeping branch is communicated. When the second height control valve 7 is closed, the second height keeping branch is cut off.

When the height of the vehicle body needs to be kept, the hydraulic suspension system 1000 may switch to enter a height keeping mode, the first height control valve 6 and the second height control valve 7 are both opened, the first height keeping branch and the second height keeping branch are communicated, and the liquid channel 204 of the left-front reducer assembly 2 is communicated with the liquid channel 204 of the right-front reducer assembly 2. The liquid channel 204 of the left-rear reducer assembly 2 is communicated with the liquid channel 204 of the left-rear reducer assembly 2. That is, the piston rod 203 of the left-front reducer assembly 2 and the piston rod 203 of the right-front reducer assembly 2 are linked, and the piston rod 203 of the left-rear reducer assembly 2 and the piston rod 203 of the right-rear reducer assembly 2 are linked, to enable the vehicle body to keep a current height as much as possible.

In some embodiments of the present disclosure, as shown in FIG. 1 to FIG. 12, the accumulator module includes the second accumulator 10. One second accumulator 10 is correspondingly arranged on each reducer assembly 2. The second accumulator 10 is communicated with the communicating channel. The stiffness-adjustment valve 11 is arranged at a liquid access port of the second accumulator 10. The first control valve 3 is located between the second accumulator 10 and the liquid storage device 1. In an embodiment, when the first control valve 3 and the stiffness-adjustment valve 11 are opened, the liquid in the liquid storage device 1 may enter the second accumulator 10 for energy storage. When the first control valve 3 is closed and the stiffness-adjustment valve 11 is opened, liquid in each second accumulator 10 may be discharged into the liquid channel 204 in the corresponding reducer assembly 2, to enable the piston rod 203 to rise. That is, the second accumulator 10 can further adjust the height of the vehicle body of the vehicle. When the stiffness needs to be increased, the first control valve 3 is closed and the stiffness-adjustment valve 11 is closed, to disconnect the second accumulator 10 from the corresponding reducer 200, thereby increasing the stiffness of the suspension.

It may be understood that, each stiffness-adjustment valve 11 may perform adjustment independently, so that stiffness on a front side and stiffness on a rear side of the hydraulic suspension system 1000 may be inconsistent, to meet different working condition requirements. For example, in an anti-dive working condition and a steering anti-tip working condition of the vehicle, a front axle needs to provide large stiffness. Therefore, the stiffness-adjustment valves 11 corresponding to the left-front reducer assembly 2 and the right-front reducer assembly 2 may be closed, and the stiffness-adjustment valves 11 corresponding to the right-rear reducer assembly 2 and the left-rear reducer assembly 2 are in an open state.

In some examples of the present disclosure, the first accumulator 9 is a metal bellows accumulator, and the second accumulator 10 is a membrane accumulator. Compared with the metal bellows accumulator, the membrane accumulator has a faster pressure storage capability and a larger pressure storage amount. The membrane accumulator may reach a larger pressure storage amount within a short time, and therefore the second accumulator 10 uses the membrane accumulator to perform pressure storage on the suspensions to lift the vehicle body. It needs to be noted that, the energy storage principle of the metal bellows accumulator and the membrane accumulator is the related art, and details are not described herein.

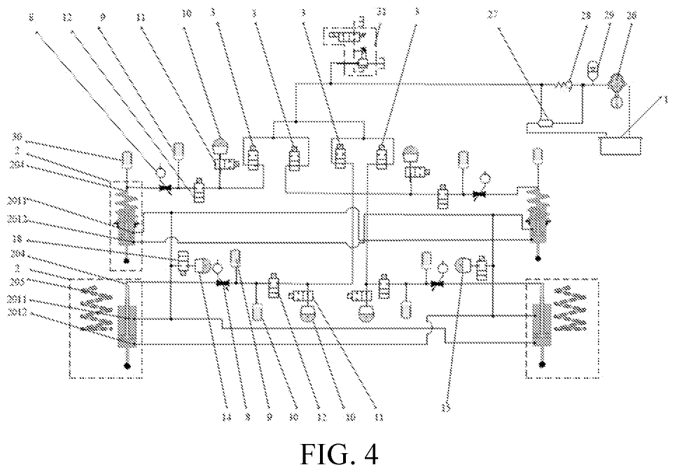

In some embodiments of the present disclosure, as shown in FIG. 1 to FIG. 9, the second control valve 12 configured to communicate or cut off the communicating channel is arranged on the communicating channel, and the second control valve 12 is located between the second accumulator 10 and the liquid channel 204. In an embodiment, the hydraulic suspension system 1000 may have a pressurization mode. As shown in FIG. 4, in the pressurization mode, the first control valve 3 is opened, the second control valve 12 is closed, and the stiffness-adjustment valve 11 is opened. The liquid in the liquid storage device 1 enters the second accumulator 10 for energy storage.

When it is necessary to switch to the lift mode, the first control valve 3 is closed, the second control valve 12 is opened, and the stiffness-adjustment valve 11 is opened. The liquid in the second accumulator 10 enters the liquid channel 204 to enable the piston 202 to rise.

When it is necessary to switch to the height reduction mode, the first control valve 3 is opened, the second control valve 12 is opened, and the stiffness-adjustment valve 11 is closed. Liquid discharged from the liquid channel 204 of the reducer 200 flows back into the liquid storage device 1. In this way, through the arrangement of the second control valve 12, energy storage may be first performed on the stiffness-adjustment valve 11. When it is necessary to perform lifting or stiffness adjustment, lifting or stiffness adjustment may be implemented by opening or closing the stiffness-adjustment valve 11, so that the response speed is fast and reliable.

In an embodiment, the hydraulic suspension system 1000 may further have a braking anti-dive and acceleration anti-lift mode. In the driving process of the vehicle, the first control valve 3 corresponding to each reducer assembly 2 may be controlled to close, the second control valve 12 may be controlled to open, and the stiffness-adjustment valve 11 may be controlled to close. The liquid channel 204 of each reducer assembly 2 is communicated with the first accumulator 9, so that the first accumulator 9 may adjust the amount of liquid in the corresponding reducer 200. Therefore, the reducer 200 corresponding to each reducer assembly 2 has a counterforce on a movement trend of the vehicle body at a corresponding position, to provide the hydraulic suspension system 1000 with the braking anti-dive and acceleration anti-lift mode.

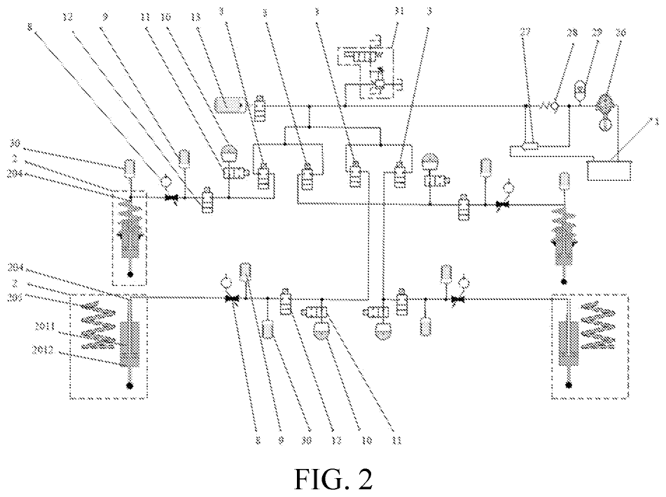

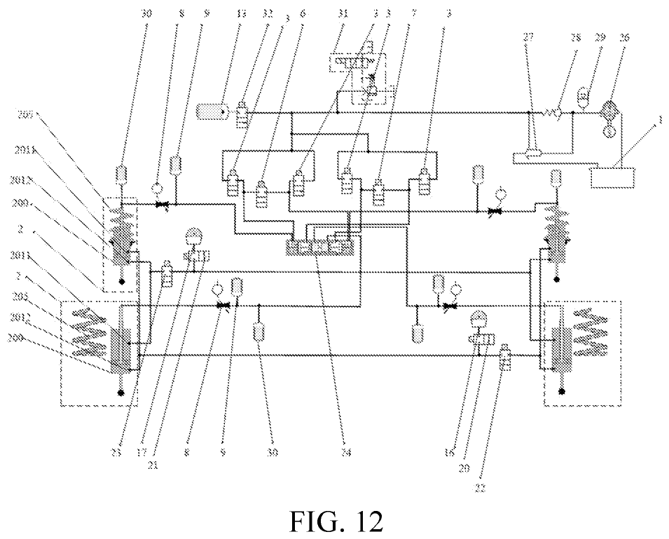

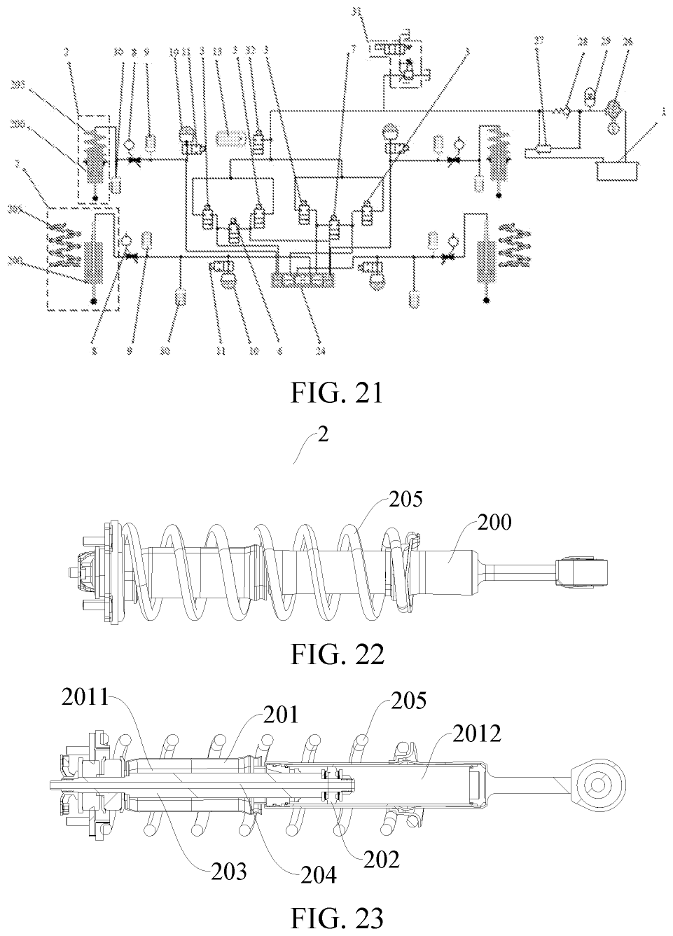

As shown in FIG. 2, FIG. 10, FIG. 12 to FIG. 19, and FIG. 21, in some embodiments of the present disclosure, the accumulator module includes a central accumulator 13. The first control valve 3 corresponding to each reducer assembly 2 is communicated with the central accumulator 13. That is, when the first control valve 3 is closed, the liquid in the liquid storage device 1 may enter the central accumulator 13 for energy storage. When the first control valve 3 is opened, liquid in the central accumulator 13 may flow into the liquid channel 204 of each reducer assembly 2. In this way, through the arrangement of the central accumulator 13, pressurization and energy storage may be performed first, to ensure that liquid can reliably flow to each reducer assembly 2, to make a quick response.

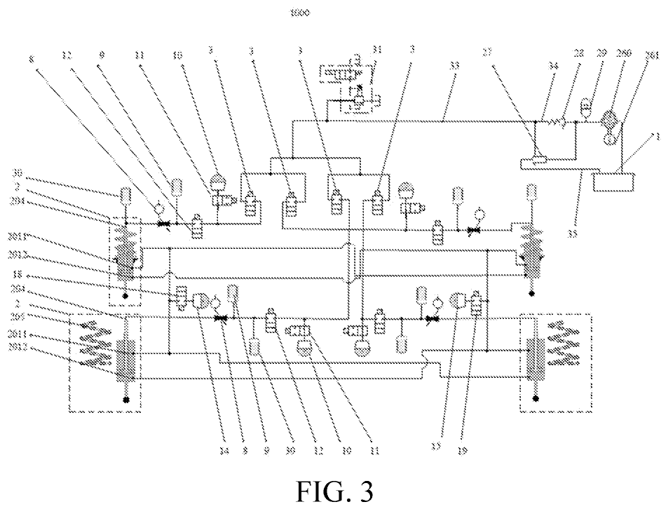

As shown in FIG. 3 to FIG. 8, in some embodiments of the present disclosure, the upper chamber 2011 of the left-front reducer assembly 2 is communicated with the lower chamber 2012 of the right-front reducer assembly 2 through a first pipe. The lower chamber 2012 of the left-front reducer assembly 2 is communicated with the upper chamber 2011 of the right-front reducer assembly 2 through a second pipe.

The upper chamber 2011 of the left-rear reducer assembly 2 is communicated with the lower chamber 2012 of the right-rear reducer assembly 2 through a third pipe. The lower chamber 2012 of the left-rear reducer assembly 2 is communicated with the upper chamber 2011 of the right-rear reducer assembly 2 through a fourth pipe.

In an embodiment, when the vehicle tends to tip, that is, the hydraulic suspension system 1000 has one side compressed and the other side extended, for example, the left-front reducer assembly 2 and the left-rear reducer assembly 2 are compressed, and the right-front reducer assembly 2 and the right-rear reducer assembly 2 are extended, in this case, liquid in the lower chamber 2012 of the left-front reducer assembly 2 enters the upper chamber 2011 of the right-front reducer assembly 2 through the second pipe, to enable the piston rod 203 of the right-front reducer assembly 2 to lower.

The liquid in the lower chamber 2012 of the left-rear reducer assembly 2 enters the upper chamber 2011 of the right-rear reducer assembly 2 through the fourth pipe, to enable the piston rod 203 of the right-rear reducer assembly 2 to lower. In this way, a downward force may be provided to the vehicle body on the right side by lowering the piston rod 203 of the right-front reducer assembly 2 and lowering the piston rod 203 of the right-rear reducer assembly 2. In this way, the hydraulic suspension system 1000 may provide an anti-tip torque to stop the vehicle from continuing to tip. It may be understood that, the foregoing description of the flow path of liquid is only an example of description to introduce an anti-tip principle. When the right side is compressed and the left side is extended, the foregoing anti-tip principle is used, and the hydraulic suspension system 1000 can provide an anti-tip force.

In an embodiment, as shown in FIG. 3 to FIG. 8, the first pipe is communicated with the third pipe to form a first return path, and the second pipe and the fourth pipe form a second return path. The hydraulic suspension system 1000 further includes a first adjustment accumulator 14 and a second adjustment accumulator 15. The first adjustment accumulator 14 is communicated with the first return path. A first adjustment valve 18 is arranged at an liquid access port of the first adjustment accumulator 14. The second adjustment accumulator 15 is communicated with the second return path. A second adjustment valve 19 is arranged at the liquid access port of the second adjustment accumulator 15.

In an embodiment, the first return path and the second return path are formed, so that linked adjustment of the right-front reducer assembly 2 with the left-front reducer assembly 2 and the left-rear reducer assembly 2 can be implemented, and linked adjustment of the right-rear reducer assembly 2 with the left-front reducer assembly 2 and the left-rear reducer assembly 2 can be implemented, to further ensure that an anti-tip torque can be provided to stop the vehicle from continuing to tip. Through the control of open or closed states of the first adjustment valve 18 and the second adjustment valve 19, stiffness of the hydraulic suspension system 1000 can be adjusted. For example, when the first adjustment valve 18 and the second adjustment valve 19 are closed, the stiffness of the hydraulic suspension system 1000 can be increased. In an embodiment, the first adjustment accumulator 14 and the second adjustment accumulator 15 may be membrane accumulators.

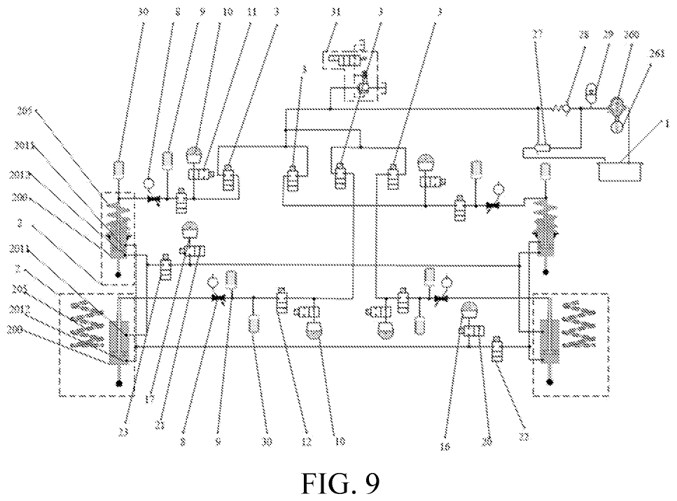

As shown in FIG. 9 to FIG. 19, in some embodiments of the present disclosure, the upper chamber 2011 of the left-front reducer assembly 2 is communicated with the lower chamber 2012 of the left-rear reducer assembly 2 through a fifth pipe. The lower chamber 2012 of the left-front reducer assembly 2 is communicated with the upper chamber 2011 of the left-rear reducer assembly 2 through a sixth pipe.

The upper chamber 2011 of the right-front reducer assembly 2 is communicated with the lower chamber 2012 of the right-rear reducer assembly 2 through a seventh pipe. The lower chamber 2012 of the right-front reducer assembly 2 is communicated with the upper chamber 2011 of the right-rear reducer assembly 2 through an eighth pipe.

In an embodiment, when the vehicle tends to pitch, that is, one of the front side and the rear side of the hydraulic suspension system 1000 is compressed and the other is extended, for example, the piston rod 203 of the left-front reducer assembly 2 and the piston rod 203 of the right-front reducer assembly 2 are compressed, liquid in the lower chamber of the left-front reducer assembly 2 flows into the upper chamber 2011 of the left-rear reducer assembly 2 through the sixth pipe, to enable the piston rod 203 of the left-rear reducer assembly 2 to lower. In this way, the front and rear are kept consistent, to implement anti-pitch.

The liquid in the lower chamber 2012 of the right-front reducer assembly 2 flows into the upper chamber 2011 of the right-rear reducer assembly 2 through the eighth pipe, to enable the piston rod 203 of the right-rear reducer assembly 2 to lower. In this way, the hydraulic suspension system 1000 may provide an anti-pitch force, to keep the vehicle from continuing to pitch.

It may be understood that, the foregoing description of the flow path of liquid is only an example of description to introduce an anti-pitch principle. When the rear side is compressed and the front side is extended, the foregoing anti-pitch principle is used, and the hydraulic suspension system 1000 can provide an anti-pitch force.

In an embodiment, as shown in FIG. 9 to FIG. 19, the fifth pipe is communicated with the seventh pipe through a first connecting pipe to form a third return path, and the sixth pipe is communicated with the eighth pipe through a second connecting pipe to form a fourth return path. The hydraulic suspension system 1000 further includes a third adjustment accumulator 16 and a fourth adjustment accumulator 17, the third adjustment accumulator 16 is communicated with the third return path, and the third adjustment valve 20 is arranged at the liquid access port of the third adjustment accumulator 16. The fourth adjustment accumulator 17 is communicated with the fourth return path, and the fourth adjustment valve 21 is arranged at the liquid access port of the fourth adjustment accumulator 17. In an embodiment, the third adjustment accumulator 16 and the fourth adjustment accumulator 17 may be membrane accumulators.

As can be learned, through the formation of the third return path and the fourth return path, linked adjustment of the right-front reducer assembly 2, the right-rear reducer assembly 2, the left-front reducer assembly 2, and the left-rear reducer assembly 2 can be implemented, so that it is further ensured that an anti-pitch torque can be provided to stop the vehicle from continuing to pitch. Through the control of open or closed states of the third adjustment valve 20 and the fourth adjustment valve 21, stiffness of the hydraulic suspension system 1000 can be adjusted. For example, when the third adjustment valve 20 and the fourth adjustment valve 21 are closed, the stiffness of the hydraulic suspension system 1000 can be increased.

In some embodiments of the present disclosure, as shown in FIG. 9 and FIG. 10, a first on-off valve 22 configured to communicate or cut off the first connecting pipe is arranged on the first connecting pipe, and a second on-off valve 23 configured to communicate or cut off the second connecting pipe is arranged on the second connecting pipe. That is, when the first on-off valve 22 is closed, the communication between the fifth pipe and the seventh pipe is blocked. When the second on-off valve 23 is closed, the communication between the sixth pipe and the eighth pipe is blocked. In this way, it may be determined, according to actual requirements, whether it is necessary to link the four reducer assemblies 2.

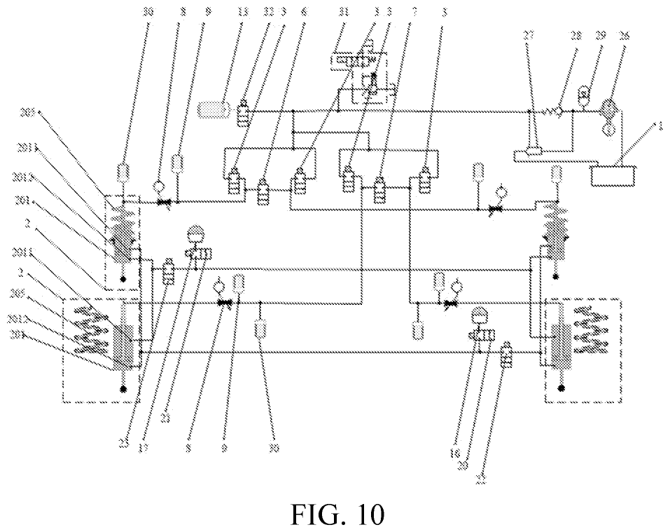

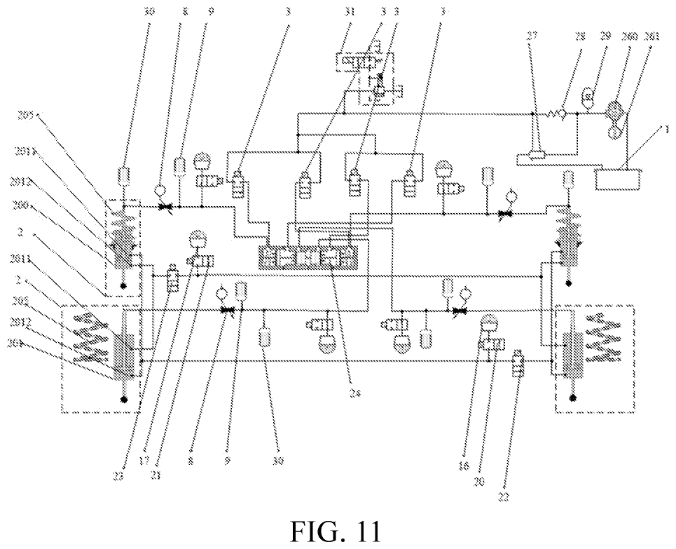

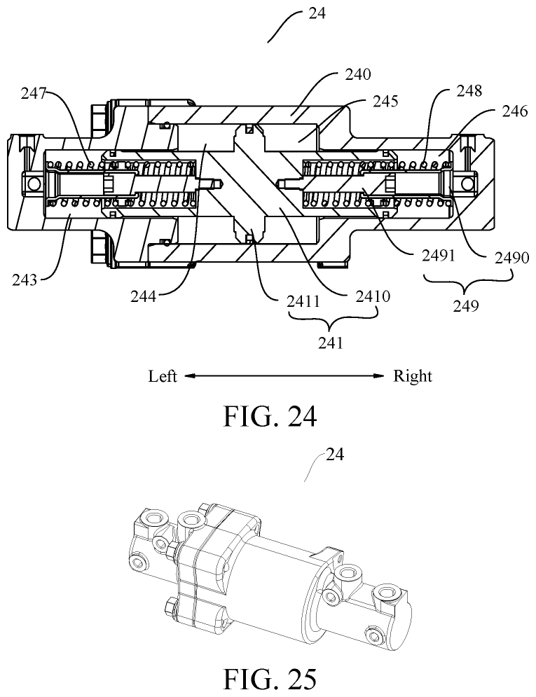

As shown in FIG. 11 to FIG. 21, FIG. 24, and FIG. 25, in some embodiments of the present disclosure, the hydraulic suspension system 1000 further includes a central control cylinder 24. The central control cylinder 24 includes a second cylinder body 240 and a movement member 241. The movement member 241 may be movably arranged in the second cylinder body 240 and fit the second cylinder body 240 to define a first chamber 243, a second chamber 244, a third chamber 245, and a fourth chamber 246. The first chamber 243, the second chamber 244, the third chamber 245, and the fourth chamber 246 are sequentially arranged in a movement direction of the movement member 241. The first chamber 243 and the second chamber 244 are distributed/disposed on one side of a middle contact portion 2411 of the movement member 241. The third chamber 245 and the fourth chamber 246 are distributed/disposed on the other side of the middle contact portion 2411. The middle contact portion 2411 movably fits an inner wall of the second cylinder body 240.

The liquid channel 204 of the left-front reducer assembly 2 is communicated with one of the first chamber 243 and the second chamber 244, and the liquid channel 204 of the right-rear reducer assembly 2 is communicated with the other one of the first chamber 243 and the second chamber 244. The liquid channel 204 of the left-rear reducer assembly 2 is communicated with one of the third chamber 245 and the fourth chamber 246, and the liquid channel 204 of the right-front reducer assembly 2 is communicated with the other one of the third chamber 245 and the fourth chamber 246. For ease of description below, an example in which the liquid channel 204 of the left-front reducer assembly 2 is communicated with the first chamber 243, the liquid channel 204 of the right-rear reducer assembly 2 is communicated with the second chamber 244, the liquid channel 204 of the left-rear reducer assembly 2 is communicated with the third chamber 245, and the liquid channel 204 of the right-front reducer assembly 2 is communicated with the fourth chamber 246 is used to describe the principle.

In an embodiment, when the vehicle tends to tip, for example, the piston rods 203 of the left-front reducer assembly 2 and the left-rear reducer assembly 2 are compressed, and the right-front reducer assembly 2 and the piston rod 203 of the right-rear reducer assembly 2 are extended, in this case, the liquid in the lower chamber 2012 of the left-front reducer assembly 2 is discharged to the first chamber 243 through the liquid channel 204, and the liquid in the lower chamber 2012 of the left-rear reducer assembly 2 is discharged to the third chamber 245 through the liquid channel 204. Because the first chamber 243 and the third chamber 245 are located on two sides of the middle contact portion 2411, a direction of a force of liquid in the first chamber 243 on the middle contact portion 2411 is opposite to a direction of a force of liquid in the third chamber 245 on the middle contact portion 2411. The forces with two opposite directions cancel each other. In this way, the movement member 241 does not move. In this way, the movement of the piston rod 203 of the piston rods 203 of the left-front reducer assembly 2 and the movement of the left-rear reducer assembly 2 can be inhibited, so that the tipping can be prevented.

When the left-front wheel encounters an obstacle, the left-front wheel is lifted. In a continuous driving process, the center of gravity of the vehicle is lifted. The right-front wheel and the left-rear wheel have a risk of leaving the ground. In this way, the vehicle has a risk of getting out of control. When the left-front wheel of the vehicle encounters an obstacle such as a rock and the left-front wheel is lifted to make a compression degree of the left-front reducer assembly 2 greater than a compression degree of the left-rear reducer assembly 2, an amount of liquid discharged from the left-front reducer assembly 2 into the first chamber 243 is greater than an amount of liquid discharged from the left-rear reducer assembly 2 into the third chamber 245. In this way, the movement member 241 moves rightward to press the third chamber 245 and the fourth chamber 246. The liquid in the third chamber 245 may be discharged into the lower chamber 2012 of the left-rear reducer assembly 2 to enable the piston rod 203 to move upward, and liquid in the fourth chamber 246 may be discharged into the lower chamber 2012 of the right-front reducer assembly 2 to enable the piston rod 203 to move upward. In this way, a possibility that the left-rear wheel and the right-front wheel leave the ground is decreased, to improve the stability of the vehicle.

It may be understood that, the foregoing several cases are only examples of descriptions. When the vehicle encounters another working condition, for example, the right-front wheel being lifted, or the left-rear wheel being lifted, liquid flows according to the foregoing linkage principle to keep the vehicle from tipping. Each working condition is not described in detail herein.

In some embodiments of the present disclosure, as shown in FIG. 24, the movement member 241 includes a movement body portion 2410. The middle contact portion 2411 is arranged at an annular protrusion on the movement body portion 2410. In the movement direction of the movement member 241, a middle cavity, a left cavity, and a right cavity are arranged in the second cylinder body 240. An extension opening of the left cavity and an extension opening of the right cavity are located in an inner wall of the middle cavity. A left end of the movement body portion 2410 extends into the left cavity through the extension opening of the left cavity, and a right end of the movement body portion 2410 extends into the right cavity through the extension opening of the right cavity.

The first chamber 243 is defined between a left end portion of the movement body portion 2410 and the left cavity. A part of the movement body portion 2410 slidably fits the inner wall of the left cavity. The middle contact portion 2411 slidably fits the inner wall of the middle cavity to define the second chamber 244 and the third chamber 245. The fourth chamber 246 is defined between a right end portion of the movement body portion 2410 and the right cavity. In this way, the structure of the central control cylinder 24 is simple.

In an embodiment, as shown in FIG. 24, the central control cylinder 24 further includes a first reset spring 247 and a second reset spring 248. Two ends of the first reset spring 247 are respectively abutted against left ends of the second cylinder body 240 and the movement member 241. Two ends of the second reset spring 248 are respectively abutted against right ends of the second cylinder body 240 and the movement member 241. The first reset spring 247 and the second reset spring 248 push the movement member 241 to be reset toward the middle. In an embodiment, when the vehicle tips to enable the movement member 241 to move leftward, the first reset spring 247 may push the movement member 241 toward the right to enable the movement member 241 to be reset. When the vehicle tips to enable the movement member 241 to move rightward, the second reset spring 248 may push the movement member 241 toward the left to enable the movement member 241 to be reset. In this way, the reliability of the central control cylinder 24 can be ensured.

In some examples of the present disclosure, as shown in FIG. 24, the central control cylinder 24 includes a guide assembly 249. The guide assembly includes a first guide member 2490 and a second guide member 2491. The first guide member 2490 slidably fits the second guide member 2491. The first guide member 2490 is fixed on the second cylinder body 240. The second guide member 2491 is fixed on the movement member 241. The first reset spring 247 is externally sleeved on the guide assembly 249 on the left side, and the first reset spring 247 is abutted against the first guide member 2490. The second reset spring 248 is externally sleeved on the guide assembly 249 on the right side, and the second reset spring 248 is abutted against the first guide member 2490. In this way, the arrangement of the guide assembly 249 makes it convenient to assemble the first reset spring 247 and the second reset spring 248, and further convenient to restrict deformation degrees of the first reset spring 247 and the second reset spring 248, to avoid a failure due to excessive deformation of the first reset spring 247 and the second reset spring 248.

In an embodiment, the second guide member 2491 is a screw, and an end of the second guide member 2491 extends into the first guide member 2490 to movably fit the first guide member 2490, making the structure of the guide assembly 249 simple and reliable.

As shown in FIG. 25, ports of the central control cylinder 24 that are connected to the piston rods 203 of the four reducer assemblies 2 are located on the same side, to facilitate pipe connection.

As shown in FIG. 1 to FIG. 23, in some embodiments of the present disclosure, each reducer assembly 2 includes a vibration reduction spring 205, and two ends of the vibration reduction spring 205 are connected to the vehicle body and the axle. In this way, through the arrangement of the vibration reduction spring 205, the cushioning effect of each reducer assembly 2 can be improved, to reduce the bumping of the vehicle body in the driving process of the vehicle.

In an embodiment, as shown in FIG. 1 to FIG. 23, the vibration reduction spring 205 of the left-front reducer assembly 2 is externally sleeved and fixed on the reducer 200. The vibration reduction spring 205 of the right-front reducer assembly 2 is externally sleeved and fixed on the reducer 200. The vibration reduction spring 205 and the reducer 200 of the left-rear reducer assembly 2 are arranged in parallel. The vibration reduction spring 205 and the reducer 200 of the right-rear reducer assembly 2 are arranged in parallel.

The hydraulic suspension system 1000 according to several embodiments of the present disclosure is described below in detail with reference to FIG. 1 to FIG. 21. It may be understood that, each foregoing embodiment is only an example of description rather than limitative description, and examples of changes may be made to each embodiment according to an actual case.

### Embodiment 1

As shown in FIG. 1, the hydraulic suspension system 1000 according to the embodiments of the present disclosure includes a left-front reducer assembly 2, a right-front reducer assembly 2, a left-rear reducer assembly 2, a right-rear reducer assembly 2, an accumulator module, a liquid storage device 1, a control pump 26, an liquid return valve 27, a one-way valve 28, a constant pressure accumulator 29, a relief valve 31, and an openness-adjustment valve 8. The accumulator module includes a first accumulator 9, a second accumulator 10, and a reduced pressure accumulator 30.

Each of the left-front reducer assembly 2 and the right-front reducer assembly 2 includes a reducer 200 and a vibration reduction spring 205. The vibration reduction spring 205 is externally sleeved and fixed on the reducer 200. Each of the left-rear reducer assembly 2 and the right-rear reducer assembly 2 includes a reducer 200 and a vibration reduction spring 205. The vibration reduction spring 205 and the reducer 200 are arranged in parallel. Two ends of the vibration reduction spring 205 of the left-rear reducer assembly 2 are respectively connected to a vehicle body and an axle. Two ends of the vibration reduction spring 205 of the right-rear reducer assembly 2 are respectively connected to the vehicle body and the axle. Each reducer 200 includes a reducer housing 201, a piston rod 203, and a piston 202. The piston rod 203 is connected to the piston 202. The piston 202 may be movably arranged in the reducer housing 201 to define an upper chamber 2011 and a lower chamber 2012. An liquid channel 204 is arranged in the piston rod 203. The liquid channel 204 is communicated with the lower chamber 2012. The liquid channel 204 of each reducer assembly 2 is communicated with the liquid storage device 1 through a communicating channel. A first control valve 3 is arranged on each communicating channel.

The liquid storage device 1 has a liquid discharge port and a liquid inlet port. The control pump 26 is communicated with the liquid discharge port and the communicating channel to guide liquid in the liquid storage device 1 to the communicating channel. The liquid return valve 27 is communicated with the liquid inlet port and the communicating channel. When the liquid return valve 27 is opened, liquid flows from the communicating channel to the liquid inlet port. The one-way valve 28 is arranged at an outlet end of the control pump 26 and is in one-way communication. The constant pressure accumulator 29 is arranged at the outlet end of the control pump 26 and is located between the one-way valve 28 and the control pump 26. The constant pressure accumulator 29 may stabilize and eliminate discharge fluctuations of the outlet end of the control pump 26.

The hydraulic suspension system 1000 includes a common flow path and four branch flow paths. The four branch flow paths are communicated with the liquid channels 204 of the four reducer assemblies 2. The one-way valve 28 and the liquid return valve 27 are respectively communicated with the common flow path. The relief valve 31 is communicated with the common flow path.

The first control valve 3 corresponding to each reducer assembly 2 is serially communicated with a corresponding branch flow path. The first control valve 3 is configured to control the branch flow path to be communicated or cut off.

The second accumulator 10 corresponding to each reducer assembly 2 is communicated with a corresponding branch flow path. A stiffness-adjustment valve 11 is arranged at an liquid access port of the second accumulator 10. The stiffness-adjustment valve 11 is in a normally-closed state.

The openness-adjustment valve 8, the first accumulator 9, and a second control valve 12 are further arranged on each branch flow path. The openness-adjustment valve 8 is configured to adjust a discharge through a corresponding branch flow path to adjust damping of the hydraulic suspension system 1000. The first accumulator 9 may perform energy storage. The second control valve 12 is arranged between the first accumulator 9 and the second accumulator 10.

One reduced pressure accumulator 30 is correspondingly arranged on each reducer assembly 2. The reduced pressure accumulator 30 corresponding to the left-front reducer assembly 2 is directly connected to the piston rod 203 to be communicated with a corresponding liquid channel 204. The reduced pressure accumulator 30 corresponding to the right-front reducer assembly 2 is directly connected to the piston rod 203 to be communicated with a corresponding liquid channel 204. The reduced pressure accumulator 30 corresponding to the left-rear reducer assembly 2 is communicated with a corresponding branch flow path. The reduced pressure accumulator 30 corresponding to the right-rear reducer assembly 2 is directly communicated with a corresponding branch flow path.

In an embodiment, the hydraulic suspension system 1000 has a pressurization mode, a lift mode, and a height reduction mode. In the pressurization mode, the first control valve 3 is opened, the second control valve 12 is closed, the stiffness-adjustment valve 11 is opened, the control pump 26 runs to enable the liquid in the liquid storage device 1 to flow into the corresponding second accumulators 10 through the four branch flow paths for energy storage. After energy storage is performed on each second accumulator 10, the stiffness-adjustment valve 11 is closed.

In the lift mode, the liquid in the liquid storage device 1 or liquid in an energy storage module may enter the liquid channel 204 of the left-front reducer assembly 2, the liquid channel 204 of the right-front reducer assembly 2, the liquid channel 204 of the left-rear reducer assembly 2, and the liquid channel 204 of the right-rear reducer assembly 2. Hydraulic liquid that enters each liquid channel 204 flows into the lower chamber 2012, to enable hydraulic pressure in the lower chamber 2012 to increase to enable the piston 202 to move upward, and the piston 202 moves upward to drive the piston rod 203 to move upward. The piston rod 203 of the left-front reducer assembly 2 moves upward, the piston rod 203 of the right-front reducer assembly 2 moves upward, the piston rod 203 of the left-rear reducer assembly 2 moves upward, and the piston rod 203 of the right-rear reducer assembly 2 moves upward to drive the vehicle body to move upward, to lift the vehicle body.

In the height reduction mode, liquid may flow out from the liquid channel 204 of the left-front reducer assembly 2, the liquid channel 204 of the right-front reducer assembly 2, the liquid channel 204 of the left-rear reducer assembly 2, and the liquid channel 204 of the right-rear reducer assembly 2. The hydraulic pressure in the lower chamber 2012 of each reducer 200 decreases to enable the piston 202 to move downward, and the piston 202 moves downward to drive the piston rod 203 to move downward. The piston rod 203 of the left-front reducer assembly 2 moves downward, the piston rod 203 of the right-front reducer assembly 2 moves downward, the piston rod 203 of the left-rear reducer assembly 2 moves downward, and the piston rod 203 of the right-rear reducer assembly 2 moves downward to drive the vehicle body to move downward, to reduce the height of the vehicle body. It may be understood that, in the height reduction mode, liquid discharged from each reducer assembly 2 may be directly discharged to the liquid storage device 1, or may be discharged into an accumulator assembly for energy storage, or is discharged to the liquid storage device 1 and the accumulator assembly.

When pressure in the hydraulic suspension system 1000 is large, for example, it is detected that pressure at an outlet of the control pump 26 reaches a threshold (30 MPa), the liquid return valve 27 is opened to release the pressure to protect the hydraulic suspension system 1000 to be within a normal pressure range. In this case, liquid in each reducer 200 may flow into the liquid storage device 1 through the communicating channel and the liquid return valve 27.

If the pressure in the hydraulic suspension system 1000 is still large or pressure is large in a running process after pressure release, the relief valve 31 may be opened to release the pressure, to ensure reliable working of the entire hydraulic suspension system 1000.

In a driving process of a vehicle, if the damping of the hydraulic suspension system 1000 is large, the vehicle body is shaky to affect comfort, an amount of liquid in each branch flow path may be adjusted through the openness-adjustment valve 8 to adjust the damping of the hydraulic suspension system 1000. When the openness of the openness-adjustment valve 8 is decreased to reduce an amount of liquid that is allowed to circulate in the communicating channel, the damping increases. When the openness of the openness-adjustment valve 8 increases, the damping decreases.

When stiffness of the hydraulic suspension system 1000 is large to reduce the comfort of the vehicle, the stiffness-adjustment valve 11 may be controlled to be opened, liquid in the second accumulator 10 may be supplemented into each branch flow path. In this way, the stiffness of the hydraulic suspension system 1000 can be reduced, and the cushioning effect of the hydraulic suspension system 1000 against bumping can be improved.

In the driving process of the vehicle, if the vehicle is impacted by bumping or the like, liquid in the lower chamber 2012 of each reducer assembly 2 may enter the reduced pressure accumulator 30 through the liquid channel 204 for energy storage, to implement quick pressure reduction. The front axle of the vehicle needs to ensure driving stability, and the rear axle of the vehicle mainly needs to ensure comfort. Therefore, the reduced pressure accumulator 30 corresponding to the left-front reducer assembly 2 is directly connected to the piston rod 203 to be communicated with a corresponding liquid channel 204. The reduced pressure accumulator 30 corresponding to the right-front reducer assembly 2 is directly connected to the piston rod 203 to be communicated with a corresponding liquid channel 204, so that quick pressure release can be implemented. The reduced pressure accumulator 30 of the rear axle may be arranged between the first accumulator 9 and the second accumulator 10, so that when flowing out of the reducer 200, liquid undergoes damping before pressure release, thereby improving comfort.

### Embodiment 2

As shown in FIG. 2, compared with Embodiment 1, the hydraulic suspension system 1000 according to this embodiment further includes a central accumulator 13 and a central energy storage adjustment valve 32. An liquid access port of the central accumulator 13 is communicated with the central energy storage adjustment valve 32. The central energy storage adjustment valve 32 is communicated with a common flow path. It needs to be noted that, in this embodiment, the same structures and modes in Embodiment 1 are not described in detail.

In the pressurization mode, the central energy storage adjustment valve 32 is opened, the stiffness-adjustment valve 11 is opened, and liquid discharged from the liquid storage device 1 enters the central accumulator 13 and the second accumulator 10 for energy storage.

In the lift mode, the central energy storage adjustment valve 32 is opened, the stiffness-adjustment valve 11 is closed, and liquid that flow out of the central accumulator 13 is discharged to the lower chamber 2012 of each reducer assembly 2, to enable the piston rod 203 to lift the vehicle body.

In the height reduction mode, liquid discharged from each reducer assembly 2 may be discharged to the central accumulator 13 and/or the liquid storage device 1.

### Embodiment 3

As shown in FIG. 3 to FIG. 8, compared with Embodiment 1, an anti-tip mode is further added to the hydraulic suspension system 1000 according to the embodiments of the present disclosure.

As shown in FIG. 3 to FIG. 8, the upper chamber 2011 of the left-front reducer assembly 2 is communicated with the lower chamber 2012 of the right-front reducer assembly 2 through a first pipe. The lower chamber 2012 of the left-front reducer assembly 2 is communicated with the upper chamber 2011 of the right-front reducer assembly 2 through a second pipe.

The upper chamber 2011 of the left-rear reducer assembly 2 is communicated with the lower chamber 2012 of the right-rear reducer assembly 2 through a third pipe. The lower chamber 2012 of the left-rear reducer assembly 2 is communicated with the upper chamber 2011 of the right-rear reducer assembly 2 through a fourth pipe. The first pipe is communicated with the third pipe to form a first return path, and the second pipe and the fourth pipe form a second return path. The hydraulic suspension system 1000 further includes a first adjustment accumulator 14 and a second adjustment accumulator 15. The first adjustment accumulator 14 is communicated with the first return path. A first adjustment valve 18 is arranged at an liquid access port of the first adjustment accumulator 14. The second adjustment accumulator 15 is communicated with the second return path. A second adjustment valve 19 is arranged at the liquid access port of the second adjustment accumulator 15.

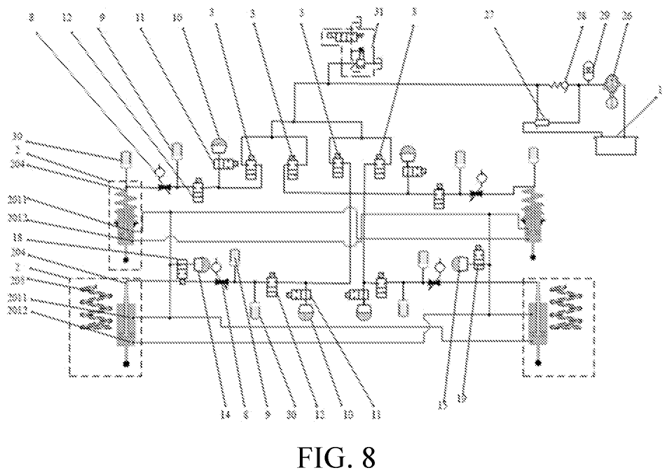

In an embodiment, as shown in FIG. 8, when the vehicle tends to tip, that is, the hydraulic suspension system 1000 has one side compressed and the other side extended, for example, the left-front reducer assembly 2 and the left-rear reducer assembly 2 are compressed, and the right-front reducer assembly 2 and the right-rear reducer assembly 2 are extended, in this case, liquid in the lower chamber 2012 of the left-front reducer assembly 2 and the lower chamber 2012 of the left-rear reducer assembly 2 enters the upper chamber 2011 of the right-front reducer assembly 2 through the second return path.

The liquid in the lower chamber 2012 of the left-rear reducer assembly 2 and the lower chamber 2012 of the left-front reducer assembly 2 enters the upper chamber 2011 of the right-rear reducer assembly 2 through the second return path, to enable the piston rod 203 of the right-front reducer assembly 2 to lower and enable the piston rod 203 of the right-rear reducer assembly 2 to lower. In this way, a downward force may be provided to the vehicle body on the right side, to keep the left and right of the vehicle consistent. In this way, the hydraulic suspension system 1000 may provide an anti-tip torque to stop the vehicle from continuing to tip. It may be understood that, the foregoing description of the flow path of liquid is only an example of description to introduce an anti-tip principle. When the right side is compressed and the left side is extended, the foregoing anti-tip principle is used, and the hydraulic suspension system 1000 can provide an anti-tip force.

As shown in FIG. 4, the first control valve 3 is opened, the second control valve 12 is closed, and the stiffness-adjustment valve 11 is opened, to perform energy storage on each second accumulator 10.

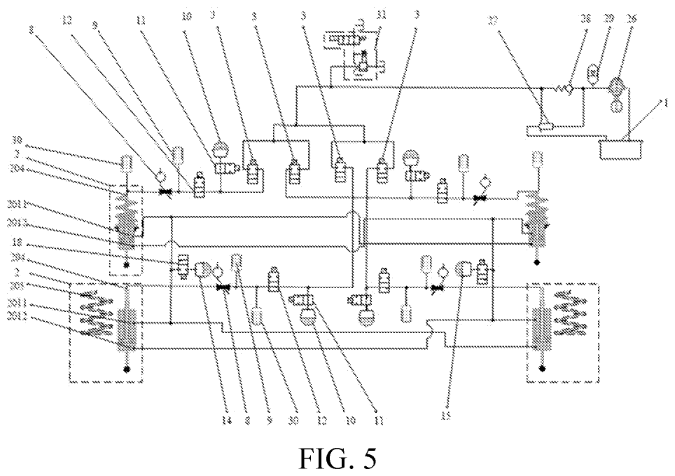

As shown in FIG. 5, in a lift working condition, the first control valve 3 is closed, the second control valve 12 opened, and the stiffness-adjustment valve 11 is opened. The liquid in the second accumulator 10 may enter an liquid channel 204 of a corresponding reducer 200 to implement lifting.

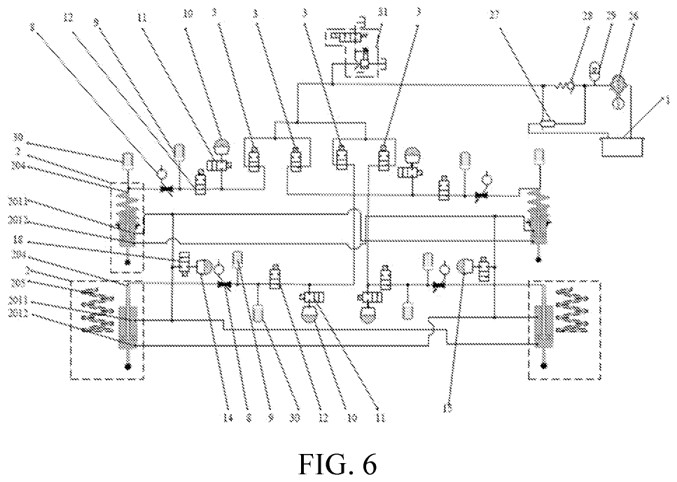

As shown in FIG. 6, in a height reduction working condition, the first control valve 3 is opened, the second control valve 12 is opened, and the stiffness-adjustment valve 11 is closed. The piston rod 203 of each reducer 200 moves downward to enable the liquid in the lower chamber 2012 to be discharged to the branch flow path through the liquid channel 204. The liquid in the four branch flow paths converges to the common flow path to flow through the liquid return valve 27 to be discharged back into the liquid storage device 1.

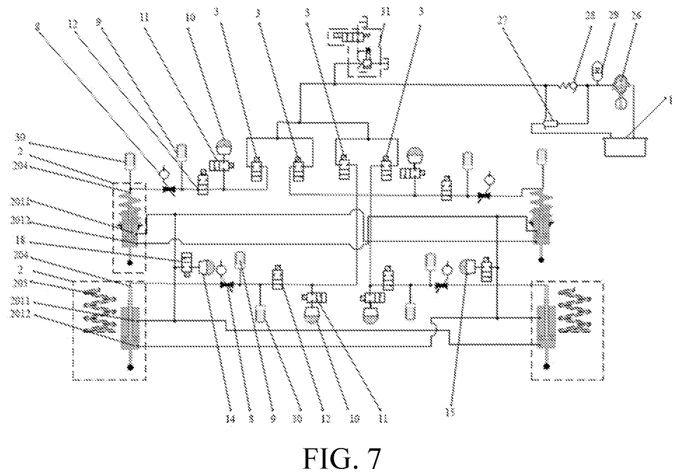

As shown in FIG. 7, the first control valve 3 is closed, the second control valve 12 is opened, and the stiffness-adjustment valve 11 is closed. The liquid in the first accumulator 9 and the reduced pressure accumulator 30 may be discharged to the liquid channel 204, or the liquid in the liquid channel 204 may be discharged to the first accumulator 9 or the reduced pressure accumulator 30 for energy storage. It may be understood that, in a starting process of the vehicle, due to an inertial force, the rear portion of the vehicle tends to sink and the front portion of the vehicle tends to rise. Because the upper chamber 2011 of the left-front reducer assembly 2 is communicated with the lower chamber 2012 in the right-front reducer assembly 2, the piston rod 203 of the left-front reducer assembly 2 and the piston rod 203 of the right-front reducer assembly 2 are kept still. In this way, the front portion of the vehicle can be inhibited from rising, thereby implementing anti-lift. Similarly, in a braking process of the vehicle, anti-dive is further implemented.

### Embodiment 4

As shown in FIG. 9, compared with Embodiment 1, in this embodiment, the hydraulic suspension system 1000 according to the embodiments of the present disclosure further has an anti-pitch mode.

The upper chamber 2011 of the left-front reducer assembly 2 is communicated with the lower chamber 2012 of the left-rear reducer assembly 2 through a fifth pipe. The lower chamber 2012 of the left-front reducer assembly 2 is communicated with the upper chamber 2011 of the left-rear reducer assembly 2 through a sixth pipe.

The upper chamber 2011 of the right-front reducer assembly 2 is communicated with the lower chamber 2012 of the right-rear reducer assembly 2 through a seventh pipe. The lower chamber 2012 of the right-front reducer assembly 2 is communicated with the upper chamber 2011 of the right-rear reducer assembly 2 through an eighth pipe. The fifth pipe is communicated with the seventh pipe through a first connecting pipe to form a third return path, and the sixth pipe is communicated with the eighth pipe through a second connecting pipe to form a fourth return path. The hydraulic suspension system 1000 further includes a third adjustment accumulator 16 and a fourth adjustment accumulator 17, the third adjustment accumulator 16 is communicated with the third return path, and the third adjustment valve 20 is arranged at the liquid access port of the third adjustment accumulator 16. The fourth adjustment accumulator 17 is communicated with the fourth return path, and the fourth adjustment valve 21 is arranged at the liquid access port of the fourth adjustment accumulator 17. A first on-off valve 22 configured to communicate or cut off the first connecting pipe is arranged on the first connecting pipe, and a second on-off valve 23 configured to communicate or cut off the second connecting pipe is arranged on the second connecting pipe.

In an embodiment, when the vehicle tends to pitch, that is, one of the front side and the rear side of the hydraulic suspension system 1000 is compressed and the other is extended, for example, the piston rod 203 of the left-front reducer assembly 2 and the piston rod 203 of the right-front reducer assembly 2 are compressed, liquid in the lower chamber 2012 of the left-front reducer assembly 2 flows into the upper chamber 2011 of the left-rear reducer assembly 2 through the sixth pipe, to enable the piston rod 203 of the left-rear reducer assembly 2 to lower.

The liquid in the lower chamber 2012 of the right-front reducer assembly 2 flows into the upper chamber 2011 of the right-rear reducer assembly 2 through the eighth pipe, to enable the piston rod 203 of the right-front reducer assembly 2 to lower. In this way, the hydraulic suspension system 1000 may provide an anti-pitch force, to keep the vehicle from continuing to pitch.

Through the formation of the third return path and the fourth return path, linked adjustment of the right-front reducer assembly 2, the right-rear reducer assembly 2, the left-front reducer assembly 2, and the left-rear reducer assembly 2 can be implemented, so that it is further ensured that an anti-pitch torque can be provided to stop the vehicle from continuing to pitch. Through the control of open or closed states of the third adjustment valve 20 and the fourth adjustment valve 21, stiffness of the hydraulic suspension system 1000 can be adjusted. For example, when the third adjustment valve 20 and the fourth adjustment valve 21 are closed, the stiffness of the hydraulic suspension system 1000 can be increased.

When the first on-off valve 22 is closed, the communication between the fifth pipe and the seventh pipe is blocked. When the second on-off valve 23 is closed, the communication between the sixth pipe and the eighth pipe is blocked. In this way, it may be determined, according to actual requirements, whether it is necessary to link the four reducer assemblies 2.

It may be understood that, the foregoing description of the flow path of liquid is only an example of description to introduce an anti-pitch principle. When the rear side is compressed and the front side is extended, the foregoing anti-pitch principle is used, and the hydraulic suspension system 1000 can provide an anti-pitch force.

### Embodiment 5

As shown in FIG. 10, compared with Embodiment 4, the second accumulator 10 is not arranged in the hydraulic suspension system 1000 according to the embodiments of the present disclosure. The hydraulic suspension system 1000 according to the embodiments of the present disclosure further includes a central accumulator 13, a first height keeping branch, and a second height keeping branch. The first height keeping branch is communicated with the liquid channel 204 of the left-front reducer assembly 2 and the liquid channel 204 of the right-front reducer assembly 2, and a first height control valve 6 configured to communicate or cut off the first height keeping branch is arranged on the first height keeping branch.

The second height keeping branch is communicated with the liquid channel 204 of the left-rear reducer assembly 2 and the liquid channel 204 of the right-rear reducer assembly 2, and a second height control valve 7 configured to communicate or cut off the second height keeping branch is arranged on the second height keeping branch.

In an embodiment, when the first height control valve 6 is opened, the first height keeping branch is communicated. When the first height control valve 6 is closed, the first height keeping branch is cut off. When the second height control valve 7 is opened, the second height keeping branch is communicated. When the second height control valve 7 is closed, the second height keeping branch is cut off.

When the height of the vehicle body needs to be kept, the hydraulic suspension system 1000 may switch to enter a height keeping mode, the first height control valve 6 and the second height control valve 7 are both opened, the first height keeping branch and the second height keeping branch are communicated, and the liquid channel 204 of the left-front reducer assembly 2 is communicated with the liquid channel 204 of the right-front reducer assembly 2. The liquid channel 204 of the left-rear reducer assembly 2 is communicated with the liquid channel 204 of the right-rear reducer assembly 2. That is, the piston rod 203 of the left-front reducer assembly 2 and the piston rod 203 of the right-front reducer assembly 2 are linked, and the piston rod 203 of the left-rear reducer assembly 2 and the piston rod 203 of the right-rear reducer assembly 2 are linked, to enable the vehicle body to keep a current height as much as possible.

In the height keeping mode, the first control valve 3 and the second control valve 12 are controlled to be kept in a closed state.

In this embodiment, in the pressurization mode, the first control valve 3 is closed, and the liquid in the liquid storage device 1 is discharged to the central accumulator 13 for energy storage.

### Embodiment 6

As shown in FIG. 11, in this embodiment, compared with Embodiment 4, the hydraulic suspension system 1000 according to the embodiments of the present disclosure further includes a central control cylinder 24.

The central control cylinder 24 includes a second cylinder body 240 and a movement member 241. The movement member 241 may be movably arranged in the second cylinder body 240 and fit the second cylinder body 240 to define a first chamber 243, a second chamber 244, a third chamber 245, and a fourth chamber 246. The first chamber 243, the second chamber 244, the third chamber 245, and the fourth chamber 246 are sequentially arranged in a movement direction of the movement member 241. The first chamber 243 and the second chamber 244 are distributed on one side of a middle contact portion 2411 of the movement member 241. The third chamber 245 and the fourth chamber 246 are distributed on the other side of the middle contact portion 2411. The middle contact portion 2411 movably fits an inner wall of the second cylinder body 240.

The liquid channel 204 of the left-front reducer assembly 2 is communicated with one of the first chamber 243 and the second chamber 244, and the liquid channel 204 of the right-rear reducer assembly 2 is communicated with the other one of the first chamber 243 and the second chamber 244. The liquid channel 204 of the left-rear reducer assembly 2 is communicated with one of the third chamber 245 and the fourth chamber 246, and the liquid channel 204 of the right-front reducer assembly 2 is communicated with the other one of the third chamber 245 and the fourth chamber 246. For ease of description below, an example in which the liquid channel 204 of the left-front reducer assembly 2 is communicated with the first chamber 243, the liquid channel 204 of the right-rear reducer assembly 2 is communicated with the second chamber 244, the liquid channel 204 of the left-rear reducer assembly 2 is communicated with the third chamber 245, and the liquid channel 204 of the right-front reducer assembly 2 is communicated with the fourth chamber 246 is used to describe the principle.

In an embodiment, when the vehicle tends to tip, for example, the piston rods 203 of the left-front reducer assembly 2 and the left-rear reducer assembly 2 are compressed, and the right-front reducer assembly 2 and the piston rod 203 of the right-rear reducer assembly 2 are extended, in this case, the liquid in the lower chamber 2012 of the left-front reducer assembly 2 is discharged to the first chamber 243 through the liquid channel 204, and the liquid in the lower chamber 2012 of the left-rear reducer assembly 2 is discharged to the third chamber 245 through the liquid channel 204. Because the first chamber 243 and the third chamber 245 are located on two sides of the middle contact portion 2411, a direction of a force of liquid in the first chamber 243 on the middle contact portion 2411 is opposite to a direction of a force of liquid in the third chamber 245 on the middle contact portion 2411. The forces with two opposite directions cancel each other. In this way, the movement member 241 does not move. In this way, the movement of the piston rod 203 of the piston rods 203 of the left-front reducer assembly 2 and the movement of the left-rear reducer assembly 2 can be inhibited, so that the tipping can be prevented.

When the left-front wheel of the vehicle encounters an obstacle such as a rock and the left-front wheel is lifted to make a compression degree of the left-front reducer assembly 2 greater than a compression degree of the left-rear reducer assembly 2, an amount of liquid discharged from the left-front reducer assembly 2 into the first chamber 243 is greater than an amount of liquid discharged from the left-rear reducer assembly 2 into the third chamber 245. In this way, the movement member 241 moves rightward to press the third chamber 245 and the fourth chamber 246. The liquid in the third chamber 245 may be discharged into the lower chamber 2012 of the left-rear reducer assembly 2 to enable the piston rod 203 to move upward, and liquid in the fourth chamber 246 may be discharged into the lower chamber 2012 of the right-front reducer assembly 2 to enable the piston rod 203 to move upward. In this way, a possibility that the left-rear wheel and the right-front wheel leave the ground is decreased, to improve the stability of the vehicle. It may be understood that, the foregoing several cases are only example of descriptions. When the vehicle encounters another working condition, for example, the right-front wheel being lifted, or the left-rear wheel being lifted, liquid flows according to the foregoing linkage principle to keep the vehicle from tipping. Each working condition is not described in detail herein.

It may be understood that, the hydraulic suspension system 1000 in this embodiment also has the anti-pitch mode described in Embodiment 4. Details are not described herein again.

### Embodiment 7

As shown in FIG. 12 to FIG. 19, in this embodiment, compared with Embodiment 4, the second accumulator 10 is canceled in the hydraulic suspension system 1000 according to the embodiments of the present disclosure. A central accumulator 13, a central control cylinder 24, a first height keeping branch, and a second height keeping branch are arranged in the hydraulic suspension system 1000 according to the embodiments of the present disclosure.

An liquid access port of the central accumulator 13 is communicated with the central energy storage adjustment valve 32. The central energy storage adjustment valve 32 is communicated with a common flow path.

The central control cylinder 24 includes a second cylinder body 240 and a movement member 241. The movement member 241 may be movably arranged in the second cylinder body 240 and fit the second cylinder body 240 to define a first chamber 243, a second chamber 244, a third chamber 245, and a fourth chamber 246. The first chamber 243, the second chamber 244, the third chamber 245, and the fourth chamber 246 are sequentially arranged in a movement direction of the movement member 241. The first chamber 243 and the second chamber 244 are distributed on one side of a middle contact portion 2411 of the movement member 241. The third chamber 245 and the fourth chamber 246 are distributed on the other side of the middle contact portion 2411. The middle contact portion 2411 movably fits an inner wall of the second cylinder body 240.

The liquid channel 204 of the left-front reducer assembly 2 is communicated with one of the first chamber 243 and the second chamber 244, and the liquid channel 204 of the right-rear reducer assembly 2 is communicated with the other one of the first chamber 243 and the second chamber 244. The liquid channel 204 of the left-rear reducer assembly 2 is communicated with one of the third chamber 245 and the fourth chamber 246, and the liquid channel 204 of the right-front reducer assembly 2 is communicated with the other one of the third chamber 245 and the fourth chamber 246.

The first height keeping branch is communicated with the liquid channel 204 of the left-front reducer assembly 2 and the liquid channel 204 of the right-front reducer assembly 2, and a first height control valve 6 configured to communicate or cut off the first height keeping branch is arranged on the first height keeping branch.

The second height keeping branch is communicated with the liquid channel 204 of the left-rear reducer assembly 2 and the liquid channel 204 of the right-rear reducer assembly 2, and a second height control valve 7 configured to communicate or cut off the second height keeping branch is arranged on the second height keeping branch.

In an embodiment, for ease of description below, an example in which the liquid channel 204 of the left-front reducer assembly 2 is communicated with the first chamber 243, the liquid channel 204 of the right-rear reducer assembly 2 is communicated with the second chamber 244, the liquid channel 204 of the left-rear reducer assembly 2 is communicated with the third chamber 245, and the liquid channel 204 of the right-front reducer assembly 2 is communicated with the fourth chamber 246 is used to describe the principle.

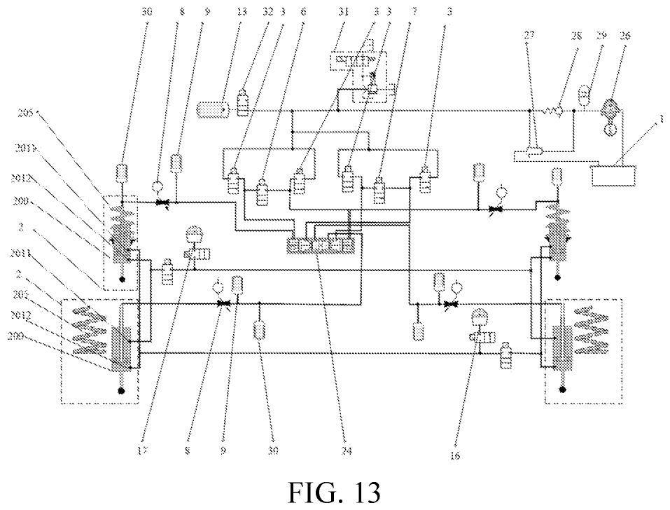

In an embodiment, as shown in FIG. 13, the hydraulic suspension system 1000 enters the pressurization mode. The central energy storage adjustment valve 32 is opened, the four first control valves 3 are closed, the first height control valve 6 is closed, and the second height control valve 7 is closed. Liquid that flows out of the liquid storage device 1 is discharged to the central accumulator 13 for energy storage.

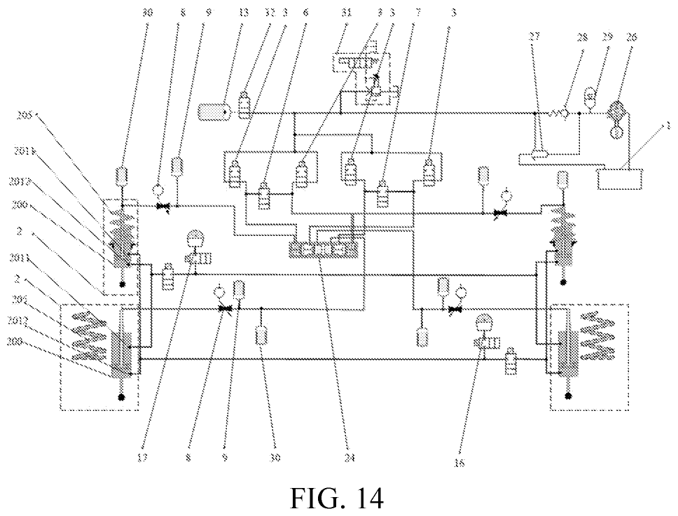

As shown in FIG. 14, when the vehicle enters the lift mode, the central energy storage adjustment valve 32 is opened, the four first control valves 3 are opened, the first height control valve 6 is closed, and the second height control valve 7 is closed.

Liquid discharged from the central accumulator 13 enters the liquid channels 204 of the four reducer assemblies 2 through the four branch flow paths. The liquid in the liquid channel 204 enters the lower chamber 2012 to enable the piston rod 203 to move upward to raise the vehicle body.

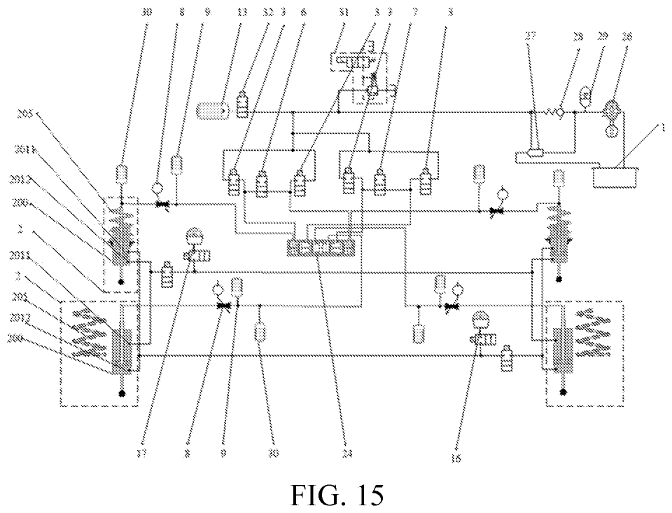

As shown in FIG. 15, when the height of the vehicle body needs to be kept, the hydraulic suspension system 1000 may switch to enter a height keeping mode, the first height control valve 6 and the second height control valve 7 are both opened, the four first control valves 3 are closed, the first height keeping branch and the second height keeping branch are communicated, and the liquid channel 204 of the left-front reducer assembly 2 is communicated with the liquid channel 204 of the right-front reducer assembly 2. The liquid channel 204 of the left-rear reducer assembly 2 is communicated with the liquid channel 204 of the right-rear reducer assembly 2. That is, the piston rod 203 of the left-front reducer assembly 2 and the piston rod 203 of the right-front reducer assembly 2 are linked, and the piston rod 203 of the left-rear reducer assembly 2 and the piston rod 203 of the right-rear reducer assembly 2 are linked, to enable the vehicle body to keep a current height as much as possible.

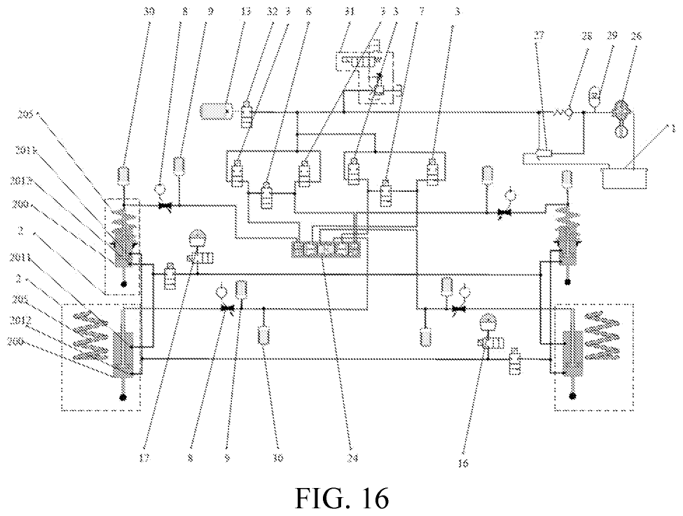

As shown in FIG. 16, when the vehicle enters the height reduction mode, the central energy storage adjustment valve 32 is closed, the four first control valves 3 are opened, the first height control valve 6 is closed, and the second height control valve 7 is closed.

Liquid discharged from the lower chamber 2012 of each reducer assembly 2 passes through the communicating channel and the liquid return valve 27 to flow back into the liquid storage device 1. In this way, each piston rod 203 moves downward to reduce the height of the vehicle body.

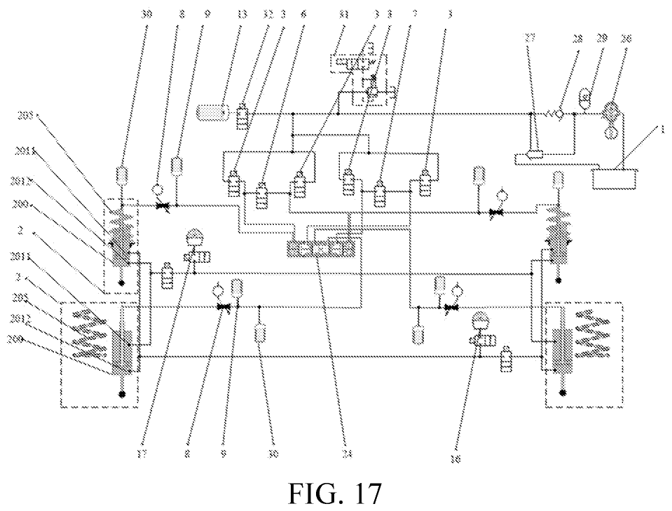

As shown in FIG. 17, the central energy storage adjustment valve 32 is closed, the first height adjustment valve 6 is closed, the second height adjustment valve 7 is closed, and the four first control valves 3 are closed.

When the vehicle tends to tip, for example, the piston rods 203 of the left-front reducer assembly 2 and the left-rear reducer assembly 2 are compressed, and the right-front reducer assembly 2 and the piston rod 203 of the right-rear reducer assembly 2 are extended, in this case, the liquid in the lower chamber 2012 of the left-front reducer assembly 2 is discharged to the first chamber 243 through the liquid channel 204, and the liquid in the lower chamber 2012 of the left-rear reducer assembly 2 is discharged to the third chamber 245 through the liquid channel 204. Because the first chamber 243 and the third chamber 245 are located on two sides of the middle contact portion 2411, a direction of a force of liquid in the first chamber 243 on the middle contact portion 2411 is opposite to a direction of a force of liquid in the third chamber 245 on the middle contact portion 2411. The forces with two opposite directions cancel each other. In this way, the movement member 241 does not move. In this way, the movement of the piston rod 203 of the piston rods 203 of the left-front reducer assembly 2 and the movement of the left-rear reducer assembly 2 can be inhibited, so that the tipping can be prevented.

When the left-front wheel of the vehicle encounters an obstacle such as a rock and the left-front wheel is lifted to make a compression degree of the left-front reducer assembly 2 greater than a compression degree of the left-rear reducer assembly 2, an amount of liquid discharged from the left-front reducer assembly 2 into the first chamber 243 is greater than an amount of liquid discharged from the left-rear reducer assembly 2 into the third chamber 245. In this way, the movement member 241 moves rightward to press the third chamber 245 and the fourth chamber 246. The liquid in the third chamber 245 may be discharged into the lower chamber 2012 of the left-rear reducer assembly 2 to enable the piston rod 203 to move upward, and liquid in the fourth chamber 246 may be discharged into the lower chamber 2012 of the right-front reducer assembly 2 to enable the piston rod 203 to move upward. In this way, a possibility that the left-rear wheel and the right-front wheel leave the ground is decreased, to improve the stability of the vehicle.

It may be understood that, the foregoing several cases are only examples of descriptions. When the vehicle encounters another working condition, for example, the right-front wheel being lifted, or the left-rear wheel being lifted, liquid flows according to the foregoing linkage principle to keep the vehicle from tipping. Each working condition is not described in detail herein.

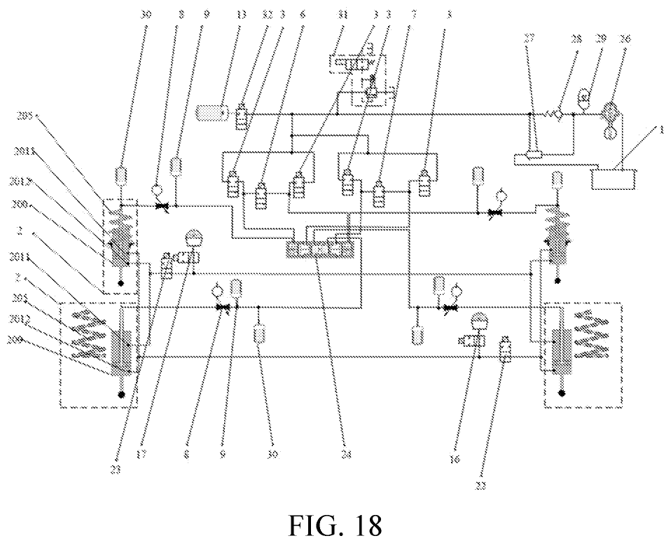

As shown in FIG. 18, the third adjustment valve 20 is opened, the fourth adjustment valve 21 is opened, the central energy storage adjustment valve 32 is closed, the first height adjustment valve 6 is closed, the second height adjustment valve 7 is closed, the four first control valves 3 is closed, the first on-off valve 22 is opened, and the second on-off valve 23 is opened.

When the vehicle tends to pitch, that is, one of the front side and the rear side of the hydraulic suspension system 1000 is compressed and the other is extended, for example, the piston rod 203 of the left-front reducer assembly 2 and the piston rod 203 of the right-front reducer assembly 2 are compressed, the piston rod 203 of the left-rear reducer assembly 2 and the piston rod 203 of the right-rear reducer assembly 2 are extended, liquid in the lower chamber 2012 of the left-front reducer assembly 2 flows into the upper chamber 2011 of the left-rear reducer assembly 2 through the sixth pipe, to enable the piston rod 203 of the left-rear reducer assembly 2 to lower.

The liquid in the lower chamber 2012 of the right-front reducer assembly 2 enters the upper chamber 2011 of the right-rear reducer assembly 2 through the eighth pipe, to enable the piston rod 203 of the right-rear reducer assembly 2 to lower. In this way, the hydraulic suspension system 1000 may provide an anti-pitch force, to keep the vehicle from continuing to pitch.

Through the formation of the third return path and the fourth return path, linked adjustment of the right-front reducer assembly 2, the right-rear reducer assembly 2, the left-front reducer assembly 2, and the left-rear reducer assembly 2 can be implemented, so that it is further ensured that an anti-pitch torque can be provided to stop the vehicle from continuing to pitch. Through the control of open or closed states of the third adjustment valve 20 and the fourth adjustment valve 21, stiffness of the hydraulic suspension system 1000 can be adjusted. For example, when the third adjustment valve 20 and the fourth adjustment valve 21 are closed, the stiffness of the hydraulic suspension system 1000 can be increased.

It may be understood that, the foregoing description of the flow path of liquid is only an example of description to introduce an anti-pitch principle. When the rear side is compressed and the front side is extended, the foregoing anti-pitch principle is used, and the hydraulic suspension system 1000 can provide an anti-pitch force.

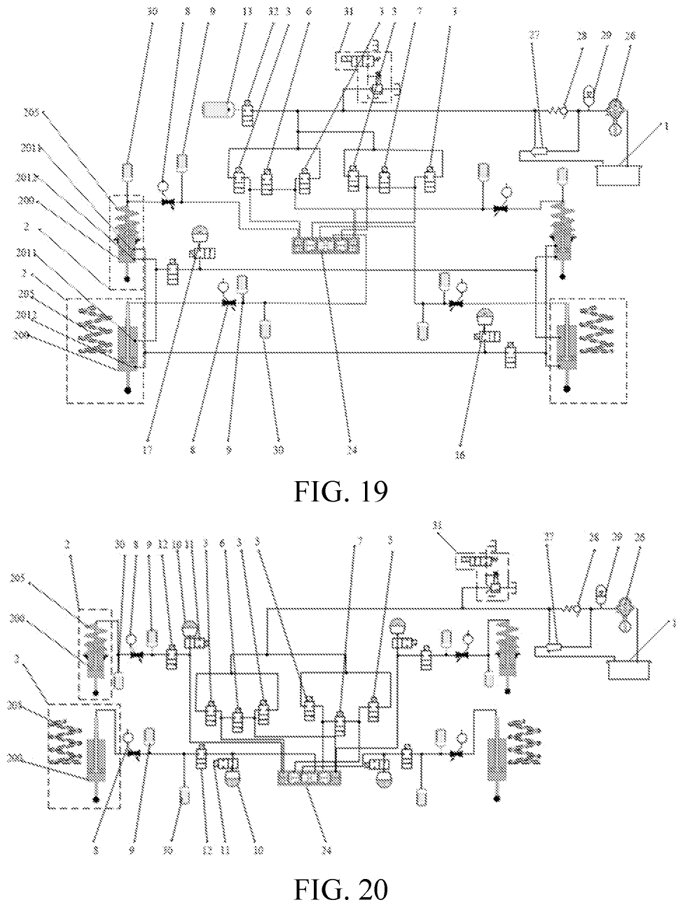

It may be understood that, when the hydraulic suspension system 1000 according to the embodiments of the present disclosure is used in an off-road vehicle, to increase an off-road RTI (Ramp travel index), as shown in FIG. 19, the third adjustment valve 20 is closed, the fourth adjustment valve 21 is closed, the central energy storage adjustment valve 32 is closed, the four first control valves 3 is closed, the first on-off valve 22 is closed, and the second on-off valve 23 is closed. The first height adjustment valve 6 is opened, and the second height adjustment valve 7 is opened.

The anti-tip principle and the height keeping principle described above are used. When an off-road vehicle travels on a bumpy mountain road, the hydraulic suspension system 1000 may provide an anti-tip force and a vehicle body height keeping force, and therefore is not prone to tipping.

### Embodiment 8

As shown in FIG. 20, in this embodiment, compared with Embodiment 1, the hydraulic suspension system 1000 according to the embodiments of the present disclosure further includes a central control cylinder 24, a first height keeping branch, and a second height keeping branch.

The central control cylinder 24 includes a second cylinder body 240 and a movement member 241. The movement member 241 may be movably arranged in the second cylinder body 240 and fit the second cylinder body 240 to define a first chamber 243, a second chamber 244, a third chamber 245, and a fourth chamber 246. The first chamber 243, the second chamber 244, the third chamber 245, and the fourth chamber 246 are sequentially arranged in a movement direction of the movement member 241. The first chamber 243 and the second chamber 244 are distributed on one side of a middle contact portion 2411 of the movement member 241. The third chamber 245 and the fourth chamber 246 are distributed on the other side of the middle contact portion 2411. The middle contact portion 2411 movably fits an inner wall of the second cylinder body 240.

The liquid channel 204 of the left-front reducer assembly 2 is communicated with one of the first chamber 243 and the second chamber 244, and the liquid channel 204 of the right-rear reducer assembly 2 is communicated with the other one of the first chamber 243 and the second chamber 244. The liquid channel 204 of the left-rear reducer assembly 2 is communicated with one of the third chamber 245 and the fourth chamber 246, and the liquid channel 204 of the right-front reducer assembly 2 is communicated with the other one of the third chamber 245 and the fourth chamber 246. For ease of description below, an example in which the liquid channel 204 of the left-front reducer assembly 2 is communicated with the first chamber 243, the liquid channel 204 of the right-rear reducer assembly 2 is communicated with the second chamber 244, the liquid channel 204 of the left-rear reducer assembly 2 is communicated with the third chamber 245, and the liquid channel 204 of the right-front reducer assembly 2 is communicated with the fourth chamber 246 is used to describe the principle.

In an embodiment, when the vehicle tends to tip, for example, the piston rods 203 of the left-front reducer assembly 2 and the left-rear reducer assembly 2 are compressed, and the right-front reducer assembly 2 and the piston rod 203 of the right-rear reducer assembly 2 are extended, in this case, the liquid in the lower chamber 2012 of the left-front reducer assembly 2 is discharged to the first chamber 243 through the liquid channel 204, and the liquid in the lower chamber 2012 of the left-rear reducer assembly 2 is discharged to the third chamber 245 through the liquid channel 204. Because the first chamber 243 and the third chamber 245 are located on two sides of the middle contact portion 2411, a direction of a force of liquid in the first chamber 243 on the middle contact portion 2411 is opposite to a direction of a force of liquid in the third chamber 245 on the middle contact portion 2411. The forces with two opposite directions cancel each other. In this way, the movement member 241 does not move. In this way, the movement of the piston rod 203 of the left-front reducer assembly 2 and the movement of the piston rod 203 of the left-rear reducer assembly 2 can be inhibited, so that the tipping can be prevented.

When the left-front wheel of the vehicle encounters an obstacle such as a rock and the left-front wheel is lifted to make a compression degree of the left-front reducer assembly 2 greater than a compression degree of the left-rear reducer assembly 2, an amount of liquid discharged from the left-front reducer assembly 2 into the first chamber 243 is greater than an amount of liquid discharged from the left-rear reducer assembly 2 into the third chamber 245. In this way, the movement member 241 moves rightward to press the third chamber 245 and the fourth chamber 246. The liquid in the third chamber 245 may be discharged into the lower chamber 2012 of the left-rear reducer assembly 2 to enable the piston rod 203 to move upward, and liquid in the fourth chamber 246 may be discharged into the lower chamber 2012 of the right-front reducer assembly 2 to enable the piston rod 203 to move upward. In this way, a possibility that the left-rear wheel and the right-front wheel leave the ground is decreased, to improve the stability of the vehicle.

It may be understood that, the foregoing several cases are only examples of descriptions. When the vehicle encounters another working condition, for example, the right-front wheel being lifted, or the left-rear wheel being lifted, liquid flows according to the foregoing linkage principle to keep the vehicle from tipping. Each working condition is not described in detail herein.

The first height keeping branch is communicated with the liquid channel 204 of the left-front reducer assembly 2 and the liquid channel 204 of the right-front reducer assembly 2, and a first height control valve 6 configured to communicate or cut off the first height keeping branch is arranged on the first height keeping branch.

The second height keeping branch is communicated with the liquid channel 204 of the left-rear reducer assembly 2 and the liquid channel 204 of the right-rear reducer assembly 2, and a second height control valve 7 configured to communicate or cut off the second height keeping branch is arranged on the second height keeping branch.

In an embodiment, when the first height control valve 6 is opened, the first height keeping branch is communicated. When the first height control valve 6 is closed, the first height keeping branch is cut off. When the second height control valve 7 is opened, the second height keeping branch is communicated. When the second height control valve 7 is closed, the second height keeping branch is cut off.

When the height of the vehicle body needs to be kept, the hydraulic suspension system 1000 may switch to enter a height keeping mode, the first height control valve 6 and the second height control valve 7 are both opened, the first height keeping branch and the second height keeping branch are communicated, and the liquid channel 204 of the left-front reducer assembly 2 is communicated with the liquid channel 204 of the right-front reducer assembly 2. The liquid channel 204 of the left-rear reducer assembly 2 is communicated with the liquid channel 204 of the left-rear reducer assembly 2. That is, the piston rod 203 of the left-front reducer assembly 2 and the piston rod 203 of the right-front reducer assembly 2 are linked, and the piston rod 203 of the left-rear reducer assembly 2 and the piston rod 203 of the right-rear reducer assembly 2 are linked, to enable the vehicle body to keep a current height as much as possible.

### Embodiment 9

As shown in FIG. 21, in this embodiment, compared with Embodiment 8, the second control valve 12 is not arranged in the hydraulic suspension system 1000 according to the embodiments of the present disclosure, and the hydraulic suspension system 1000 includes a central accumulator 13.

It needs to be noted that, in this embodiment, in the pressurization mode, the liquid in the liquid storage device 1 flows to the central accumulator 13 and the second accumulator 10 for energy storage.

The modes of the hydraulic suspension system 1000 in this embodiment are the same as those in Embodiment 8. Details are not described herein.

It needs to be noted that, the foregoing nine embodiments are only examples of descriptions. The modes of the hydraulic suspension system 1000 are not exhaustively described in each embodiment. The foregoing nine embodiments all have the lift mode, the height reduction mode, damping adjustment, and the like. Details are not described in each embodiment.

A vehicle according to embodiments of the present disclosure includes the hydraulic suspension system 1000 according to any foregoing embodiment of the present disclosure.

The vehicle according to the embodiments of the present disclosure may adjust the height of the vehicle body according to a road condition or the like. For example, on a relatively bumpy mountain road, the hydraulic suspension apparatus may enter the lift mode to raise the center of gravity of the vehicle, thereby improving the driving stability of the vehicle. When an impact of the vehicle body on a driving speed needs to be reduced, the hydraulic suspension apparatus may enter the height reduction mode to lower the center of gravity of the vehicle. It may be understood that, the foregoing is only an example of description, and the height of the vehicle body may be adjusted according to an actual requirement in a driving process.

The vehicle according to the embodiments of the present disclosure may adjust a height of a vehicle body, and can improve the operation stability of a vehicle without damaging the comfort of the vehicle, so that the contradiction between the comfort and the steering stability of the vehicle is effectively resolved. In addition, the weight can be reduced by using the hollow piston rod 203, and the liquid channel 204 defined by the hollow piston rod 203 is further used to implement intake or discharge of liquid to adjust the position of the piston rod 203. The adjustment manner is simple, the reliability is high, the costs are low, and the response speed is fast. Further, the liquid channel 204 communicated with the lower chamber 2012 is opened at the piston rod 203, and the liquid channel 204 is communicated with the liquid storage apparatus. Therefore, an liquid path can be stably communicated, wear or the like at a joint due to vibration is avoided, and liquid leakage at a joint can be avoided as much as possible.

Other structures such as a braking system and operations of the vehicle according to the embodiments of the present disclosure are known to those of ordinary skill in the art, and details are not described herein again.

In the description of the present disclosure, it should be understood that, orientations or position relationships indicated by terms such as “center”, “longitudinal”, “transverse”, “length”, “width”, “thickness”, “up”, “down”, “front”, “back”, “left”, “right”, “vertical”, “horizontal”, “top”, “bottom”, “inner”, “outer”, “clockwise”, “counterclockwise”, “axial”, “radial”, and “circumferential” are orientations or position relationship shown based on the accompanying drawings, and are merely used for describing the present disclosure and simplifying the description, rather than indicating or implying that the apparatus or element should have a particular orientation or be constructed and operated in a particular orientation, and therefore, should not be construed as a limitation on the present disclosure.

In addition, terms “first” and “second” are used only for describing objectives, and shall not be construed as indicating or implying relative importance or implying a quantity of indicated technical features. Therefore, a feature restricted by “first” or “second” may explicitly indicate or implicitly include one or more such features. In descriptions of the present disclosure, “multiple” means more than two, unless otherwise defined clearly and specifically.

In the present disclosure, unless otherwise clearly specified and limited, terms “mount”, “connect”, and “fix” should be understood in a generalized manner, for example, may be understood as fixed connection, detachable connection, or integration; or may be understood as mechanical connection or electrical connection; or may be understood as direct connection, or indirect connection by means of a medium, or internal communication of two elements or a mutual relationship between two elements. A person of ordinary skill in the art may understand meanings of the terms in the present disclosure according to situations.

In the present disclosure, unless explicitly specified or limited otherwise, a first characteristic “on” or “under” a second characteristic may be the first characteristic in direct contact with the second characteristic, or the first characteristic in indirect contact with the second characteristic by using an intermediate medium. Moreover, the first feature “on”, “above” and “on the top of” the second feature may be that the first feature is directly above or obliquely above the second feature, or merely that the level of the first feature level is higher than that of the second feature. The first feature “under”, “below” and “on the bottom of” the second feature may be that the first feature is directly below or obliquely below the second feature, or merely that the level of the first feature is lower than that of the second feature.

In description of the specification, description of reference terms such as “one embodiment”, “some embodiments”, “example”, “specific example” or “some examples” means including features, structures, materials, or features described in the embodiment or example in at least one embodiment or example of the present disclosure. In this specification, schematic descriptions of the foregoing terms do not refer a same embodiment or example. In addition, the described features, structures, materials, or features can be combined in a proper manner in any one or more embodiments or examples. Moreover, different embodiments or examples and features of different embodiments or examples described in the specification can be synthesized and combined by those skilled in the art as long as no conflict occurs.

Although the embodiments of the present disclosure are shown and described above, it can be understood that, the foregoing embodiments are examples, and cannot be construed as a limitation to the present disclosure. Within the scope of the present disclosure, a person of ordinary skill in the art may make changes, modifications, replacement, and variations to the foregoing embodiments.

What is claimed is:

1. A hydraulic suspension apparatus, configured to adjust a height of a vehicle body of a vehicle, comprising:
a liquid storage apparatus disposed on the vehicle body and configured to store liquid; and
a reducer having a reducer housing, a piston, and a piston rod, the reducer housing connected to an axle, the piston located in the reducer housing and dividing the reducer housing into an upper chamber and a lower chamber, an end of the piston rod connected to the piston, the piston rod connected to the vehicle body and comprising a liquid channel, the liquid channel communicated with the lower chamber and the liquid storage apparatus to enable liquid flowable between the liquid storage apparatus and the lower chamber.

2. The hydraulic suspension apparatus according to claim 1, wherein the liquid storage apparatus comprises a control pump and a liquid storage device, and the control pump is disposed between the liquid storage device and the liquid channel.

3. The hydraulic suspension apparatus according to claim 1, wherein an upper end of the piston rod extends out of the reducer housing, a liquid port is formed at the upper end of the piston rod, and the liquid port is configured to communicate the liquid channel with the liquid storage apparatus.

4. The hydraulic suspension apparatus according to claim 2, further comprising a liquid outlet channel and a liquid return channel, wherein the liquid outlet channel and the liquid return channel are communicated between the liquid storage device and the liquid channel, the liquid outlet channel and the liquid return channel partially overlap, and the control pump is disposed on the liquid outlet channel.

5. The hydraulic suspension apparatus according to claim 4, wherein the liquid outlet channel comprises a shared channel and a liquid outlet branch; the liquid return channel comprises the shared channel and a liquid return branch; a first end of the shared channel is communicated with the liquid channel; and the liquid outlet branch and the liquid return branch are communicated with a second end of the shared channel.

6. The hydraulic suspension apparatus according to claim 5, wherein a one-way valve and the control pump are disposed on the liquid outlet branch, a first end of the one-way valve is communicated with the shared channel, a second end of the one-way valve is communicated with the control pump, and a liquid return valve is disposed on the liquid return branch.

7. The hydraulic suspension apparatus according to claim 1, further comprising an accumulator module, wherein the liquid channel is communicated with the liquid storage apparatus through a communicating channel, the accumulator module is communicated with the communicating channel and configured to adjust at least one of damping of the reducer, stiffness of the reducer, and the height of the vehicle body of the vehicle.

8. The hydraulic suspension apparatus according to claim 7, further comprising a first control valve, wherein the first control valve is disposed on the communicating channel, and is configured to control communication or separation between the liquid storage apparatus and the accumulator module.

9. The hydraulic suspension apparatus according to claim 7, wherein the accumulator module comprises a first accumulator and an openness-adjustment valve, the first accumulator is communicated with the communicating channel at a first communicating point, the openness-adjustment valve is disposed between the first communicating point and the liquid channel, the openness-adjustment valve is configured to adjust a flow between the liquid channel and the first communicating point to adjust the damping of the reducer, and the openness-adjustment valve is configured to turn off the flow between the liquid channel and the first communicating point to adjust the stiffness of the reducer.

10. The hydraulic suspension apparatus according to claim 7, wherein the accumulator module comprises a second accumulator and a stiffness-adjustment valve, the second accumulator is communicated with the communicating channel at a second communicating point, the stiffness-adjustment valve is disposed between the second accumulator and the second communicating point, and configured to enable communication or separation between the communicating channel and the second accumulator to adjust the stiffness of the reducer.

11. The hydraulic suspension apparatus according to claim 10, further comprising a second control valve disposed between the second communicating point and the liquid channel.

12. The hydraulic suspension apparatus according to claim 7, wherein the accumulator module comprises a first accumulator and a second accumulator, the first accumulator is communicated with the communicating channel at a first communicating point, and the second accumulator is communicated with the communicating channel at a second communicating point.

13. The hydraulic suspension apparatus according to claim 12, wherein the first communicating point is located between the liquid channel and the second communicating point.

14. The hydraulic suspension apparatus according to claim 12, further comprising a second control valve disposed between the first communicating point and the second communicating point.

15. A hydraulic suspension system, comprising a controller and a hydraulic suspension apparatus, the controller being configured to control a flow direction of liquid between a liquid storage apparatus and a reducer of the hydraulic suspension apparatus according to a status of a vehicle, to adjust a height of a vehicle body of the vehicle, wherein:
a liquid storage apparatus disposed on the vehicle body and configured to store liquid; and
a reducer having a reducer housing, a piston, and a piston rod, the reducer housing connected to an axle, the piston located in the reducer housing and dividing the reducer housing into an upper chamber and a lower chamber, an end of the piston rod connected to the piston, the piston rod connected to the vehicle body and comprising a liquid channel, the liquid channel communicated with the lower chamber and the liquid storage apparatus to enable liquid flowable between the liquid storage apparatus and the lower chamber.

16. The hydraulic suspension system according to claim 15, wherein the liquid storage apparatus comprises a control pump and a liquid storage device, and the control pump is disposed between the liquid storage device and the liquid channel.

17. The hydraulic suspension system according to claim 15, wherein an upper end of the piston rod extends out of the reducer housing, a liquid port is formed at the upper end of the piston rod, and the liquid port is configured to communicate the liquid channel with the liquid storage apparatus.

18. The hydraulic suspension system according to claim 16, further comprising a liquid outlet channel and a liquid return channel, wherein the liquid outlet channel and the liquid return channel are communicated between the liquid storage device and the liquid channel, the liquid outlet channel and the liquid return channel partially overlap, and the control pump is disposed on the liquid outlet channel.

19. The hydraulic suspension system according to claim 18, wherein the liquid outlet channel comprises a shared channel and a liquid outlet branch; the liquid return channel comprises the shared channel and a liquid return branch; a first end of the shared channel is communicated with the liquid channel; and the liquid outlet branch and the liquid return branch are communicated with a second end of the shared channel.

20. A vehicle, comprising a hydraulic suspension system, the hydraulic suspension system comprising a controller and a hydraulic suspension apparatus, the controller being configured to control a flow direction of liquid between a liquid storage apparatus and a reducer of the hydraulic suspension apparatus according to a status of the vehicle, to adjust a height of a vehicle body of the vehicle, wherein:
a liquid storage apparatus disposed on the vehicle body and configured to store liquid; and
a reducer having a reducer housing, a piston, and a piston rod, the reducer housing connected to an axle, the piston located in the reducer housing and dividing the reducer housing into an upper chamber and a lower chamber, an end of the piston rod connected to the piston, the piston rod connected to the vehicle body and comprising a liquid channel, the liquid channel communicated with the lower chamber and the liquid storage apparatus to enable liquid flowable between the liquid storage apparatus and the lower chamber.
